(19) United States
(12) Patent Application Publication
(10) Pub. No.: US 2010/0106873 A1
(43) Pub. Date: Apr. 29, 2010

(54) DATA OPERATION APPARATUS AND DATA OPERATION SYSTEM AND COMPUTER PROGRAM AND DATA OPERATION METHOD

(75) Inventors: Hidetoshi FUNAKURA, Tokyo (JP); Toshihisa Kamemaru, Tokyo (JP); Satoshi Arakawa, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Chiyoda-ku (JP)

(21) Appl. No.: 12/435,012

(22) Filed: May 4, 2009

(30) Foreign Application Priority Data
Oct. 29, 2008 (JP) 2008-278430

(51) Int. Cl. G06F 13/42

(52) U.S. Cl. 710/106

(57) ABSTRACT

The identification acquirement instructing unit 171 transmits an identification acquiring command to the storage apparatus (the IC tag). The identification receiving unit 181 receives the identification information of the storage apparatus. The protocol deciding unit 130, based on the identification information of the storage apparatus, decides the group of the extension commands (the protocols) that the storage apparatus can interprets. and the extension command transforming unit 140 transforms the common command acquired by the common command acquiring unit 161 to an extension command. the command transmitting unit 172 transmits it to the storage apparatus.

### BACKGROUND OF THE INVENTION

1. Field of the Invention

The present invention relates to a data operation apparatus that communicates with a storage apparatus such as an integrated circuit (IC) tag and operates data stored by the storage apparatus.

2. Description of the Related Art

EPC Global standardizes communication protocols that are used to communicate with IC tags. Among them, a standard mentioned in non-patent document 1 (hereinafter referred to as the “C1G2”) is used popularly.

In the C1G2, an IC tag has a memory area (the user memory) that can be written on freely by an user, besides a normal memory area that stores TID and the like. Recently, the IC tag with a user memory having a large volume of several kilobits up to several hundreds of kilobits is being sold. Since the C1G2 does not provide with an air command that can efficiently operate the user memory having a large volume, therefore, manufacturers of the IC tags extend the air commands uniquely. The extended air commands are not unified, and they are different depending on the manufacturers even if they implement the identical or similar functions.
[Patent Document 1] Japanese Published Patent Application No. 2008-90405
[Patent Document 2] Japanese Published Patent Application No. 2007-318323
[Patent Document 3] Japanese Published Patent Application No. 2005-284455
[Patent Document 4] Japanese Published Patent Application No. Hei 11-184649
[Non-Patent Document 1] “EPC Radio-Frequency Identity Protocols Class-1 Generation-2 UHF RFID Protocol for Communications at 860 MHz-960 MHz Version 1.1.0” EPC global, 2006

A large amount of IC tags will be required in logistic system that utilizes the IC tags. If an application using an extended air command of a specific manufacturer is used in such a system, the IC tags of other manufacturers cannot be used. For this reason, once the system is constructed, the IC tags must be purchased in large amounts from the specific manufacturer afterwards. So, it cannot be expected that free competitions of price bring in a reduction in cost of the system.

The present invention, for example, attempts to solve the problem mentioned above. For example, the present invention aims to make possible the data operation apparatus that operates data stored by the storage apparatus such as the IC tag, by transmitting a command to the storage apparatus, in accordance to an instruction from a control apparatus executing the application and the like, to operate the data without awareness of the situation by the control apparatus, even if it is the situation where plural kinds of storage apparatuses that interpret different commands are intermingled.

### SUMMARY OF THE INVENTION

According to one aspect of the present invention, a data operation apparatus that communicates with a storage apparatus according to an instruction from a control apparatus, and operates data stored by the storage apparatus, comprises: a processing apparatus that processes data; a transmitting apparatus that transmits data to the storage apparatus; a receiving apparatus that receives data from the storage apparatus; a common command acquiring unit; an identification acquirement instructing unit; an identification receiving unit; a command group deciding unit; an extension command transforming unit; an extension command transmitting unit; a response receiving unit; a response transforming unit; and a response notifying unit; and wherein the common command acquiring unit, by using the processing apparatus, acquires a common command indicating the instruction from the control apparatus; wherein the identification acquirement instructing unit, by using the transmitting apparatus, transmits to the storage apparatus an identification acquiring command that instructs to transmit an identification information of the storage apparatus; wherein the identification receiving unit, by using the receiving apparatus, receives the identification information transmitted by the storage apparatus, as a response to the identification acquiring command transmitted by the identification acquirement instructing unit; wherein the command group deciding unit, by using the processing apparatus, decides a group of extension commands that the storage apparatus interprets, among a plurality of groups of the extension commands, based on the identification information received by the identification receiving unit; wherein the extension command transforming unit, by using the processing apparatus, transforms a common command acquired by the common command acquiring unit, to an extension command that the storage apparatus interprets, based on the group of the extension commands decided by the command group deciding unit; wherein the extension command transmitting unit, by using the transmitting apparatus, transmits to the storage apparatus the extension command transformed by the extension command transforming unit; wherein the response receiving unit, by using the receiving apparatus, receives a response data transmitted by the storage apparatus, as a response to the extension command transmitted by the extension command transmitting unit; wherein the response transforming unit, by using the processing apparatus, transforms a data format of the response data received by the response receiving unit into a prescribed format, to generate a transformed data; and wherein the response notifying unit, by using the processing apparatus, notifies the control apparatus of the transformed data generated by the response transforming unit, as a response to the common command acquired by the common command acquiring unit.

According to the data operation apparatus of the present invention, even if it is a situation where a plurality of storage apparatuses that interpret different extension commands are intermingled, the data stored by the storage apparatuses interpreting different extension commands can be operated by using the same command, without having to be aware of it by the control apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a system configuration chart showing one example of the overall configuration of an IC tag readout system 800, in accordance with the first embodiment.

FIG. 2 is a hardware configuration chart showing one example of the hardware configuration of a RFID reader/writer apparatus 100, in accordance with the first embodiment.

FIG. 3 is a block configuration chart showing one example of a functional block configuration of the RFID reader/writer apparatus 100, in accordance with the first embodiment.

FIG. 4 illustrates an example oft correspondences of block numbers of block operation commands between the common commands and the extension commands unique to various manufacturers, in accordance with the first embodiment.

FIG. 5 illustrates one example of a protocol table 520 stored by a protocol storing unit 120, in accordance with the first embodiment.

FIG. 6 is a flow chart showing one example of the flow of a block read command transforming process in which an extension command transforming unit 140 of the first embodiment transforms a block read command.

FIG. 7 illustrates a specific example of the relation between the common command acquired by a common command acquiring unit 161 and the extension command transformed by the extension command transforming unit 140, in accordance with the first embodiment.

FIG. 8 is a flow chart showing an example of the flow of a block write command transforming process in which the extension command transforming unit 140 of the first embodiment transforms a block write command.

FIG. 9 illustrates a specific example of a relation between the common command acquired by the common command acquiring unit 161 and the extension command transformed by the extension command transforming unit 140, in accordance with the first embodiment.

FIG. 10 is a flow chart showing one example of the flow of a block read response transforming process in which a response transforming unit 150 of the first embodiment transforms a response to the block read command.

FIG. 11 illustrates a specific example of a relation between a response data received by a response receiving unit 182 and a transformed data transformed by the response transforming unit 150, in accordance with the first embodiment.

FIG. 12 is a block configuration chart showing one example of a functional block configuration of the RFID reader/writer apparatus 100 in accordance with the second embodiment.

FIG. 13 is a block configuration chart showing one example of a detailed block configuration of the protocol storing unit 120, in accordance with the second embodiment.

FIG. 14 is a block configuration chart showing one example of a detailed block configuration of the protocol storing unit 120, in accordance with the third embodiment.

FIG. 15 is a block configuration chart showing one example of a detailed block configuration of the extension command transforming unit 140, in accordance with the fourth embodiment.

FIG. 16 is a flow chart showing one example of the flow of a block operation command transforming process in which the extension command transforming unit 140 of the fourth embodiment transforms a block operation command.

FIG. 17 illustrates a specific example of a relation between the common block operation commands and the extension block operation commands, which are sources and results of the transformation by the extension command transforming unit 140, and a relation between the response data and the transformed data, which are sources and results of the transformation by the response transforming unit 150, in accordance with the fourth embodiment.

FIG. 18 is a block configuration chart showing one example of a detailed block configuration of the extension command transforming unit 140 and the response transforming unit 150, in accordance with the fifth embodiment.

FIG. 19 is a flow chart showing one example of the flow of the block operation command transforming process in which the extension command transforming unit 140 of the fifth embodiment transforms the block operation command.

FIG. 20 is a flow chart showing one example of the flow of a retry process S650 in which the extension command transforming unit 140 performs a retry, in accordance with the fifth embodiment.

FIG. 21 illustrates a specific example of the relations between the common block operation command and the extension operation commands transformed by the extension command transforming unit 140, and the relations between the response data and the transformed data transformed by the response transforming unit 150, in accordance with the fifth embodiment.

### DETAILED DESCRIPTION OF THE EMBODIMENTS

Various exemplary embodiments, features, and aspects of the invention will be described in detail below with reference to the drawings.

### First Embodiment

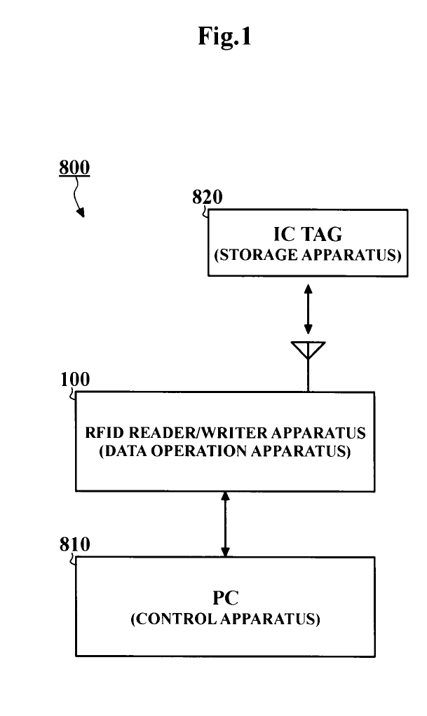

The first embodiment is described with reference to the drawings of FIGS. 1 to 11.

FIG. 1 is the system configuration chart showing one example of the overall configuration of the IC tag readout system 800, in accordance with the present embodiment.

The IC tag readout system 800 (one example of the data operation system) includes a PC 810, the RFID reader/writer apparatus 100, and a plurality of IC tags 820.

The RFID (Radio Frequency Identification) reader /writer apparatus 100 (one example of the data operation apparatus) supplies electric power to the IC tags 820 by transmitting electrical waves from an antenna. At the same time, it transmits commands to the IC tags 820 and receives responses from the IC tags 820.

The RFID reader/writer apparatus 100 is connected to the PC (personal computer) 810 (one example of the control apparatus). The RFID reader/writer apparatus 100 transmits a command to an IC tag 820 in accordance to the instruction from the PC 810, and notifies the PC 810 of a response from the IC tag 820.

The IC tag 820 (one example of the storage apparatus) has the memory area that stores identification information of the IC tag 820 itself and other data. The IC tag 820 operates by receiving electric power supplied by means of electrical waves transmitted by the RFID reader/writer apparatus 100. The IC tag 820 demodulates the electrical waves transmitted by the RFID reader/writer apparatus 100, to receive the command transmitted by the RFID reader/writer apparatus 100, and performs operations such as transmitting a requested data to the RFID reader/writer apparatus 100, or storing the data received from the RFID reader/writer apparatus 100 to a specified memory area, in accordance with the received command.

The IC tag 820 interprets, for example, commands defined based on the standard such as C1G2 (hereinafter referred to as the “basic commands”), as well, it interprets commands which are uniquely extended by each of manufacturers of the IC tags 820 (hereinafter referred to as the “extension commands”). The IC tag 820 operates according to instruction of the interpreted commands.

Among the basic commands, for example, there are “select command” that selects a group of IC tags for communication, “query command” that fixes a single IC tag from the IC tags as the subject of the communication, and “Ack command” that reads an ID of the IC tag.

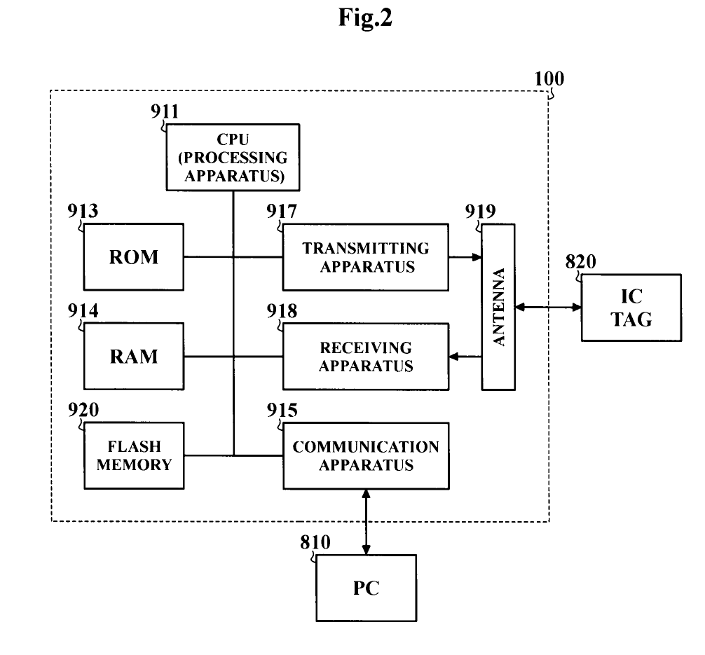

FIG. 2 is the hardware configuration showing one example of the hardware configuration of the RFID reader/writer apparatus 100, in accordance with the present embodiment.

The RFID reader/writer apparatus 100 includes a ROM 913, a RAM 914, a flash memory 920, a CPU 911, a communication apparatus 915, a transmitting apparatus 917, a receiving apparatus 918, and the antenna 919.

The ROM (Read Only Memory) 913, the RAM (Random Access Memory) 914, and the flash memory 920 are apparatuses for storing programs, data, and so forth on.

The CPU (Central Processing Unit) 911 (one example of the processing apparatus) is an apparatus that processes data stored, for example, on the RAM 914, by executing a program stored, for example, on the ROM 913.

The communication apparatus 915 is an apparatus that communicate to the PC 810, based on an instruction from the CPU 911. The communication apparatus 915 transmits the data stored on the RAM 914 to the PC 810, and receives data from the PC 810, and stores the data to the RAM 914, for example.

The transmitting apparatus 917 is an apparatus that transmits commands and other data to the IC tag 820, via the antenna 919, based on an instruction from the CPU 911. The transmitting apparatus 917 transmits the data stored on the RAM 914, for example, to the IC tag 820.

The receiving apparatus 918 is an apparatus that receives data transmitted by the IC tag 820, via the antenna 919, based on an instruction from the CPU 911. The receiving apparatus 918 stores the received data, for example, to the RAM 914.

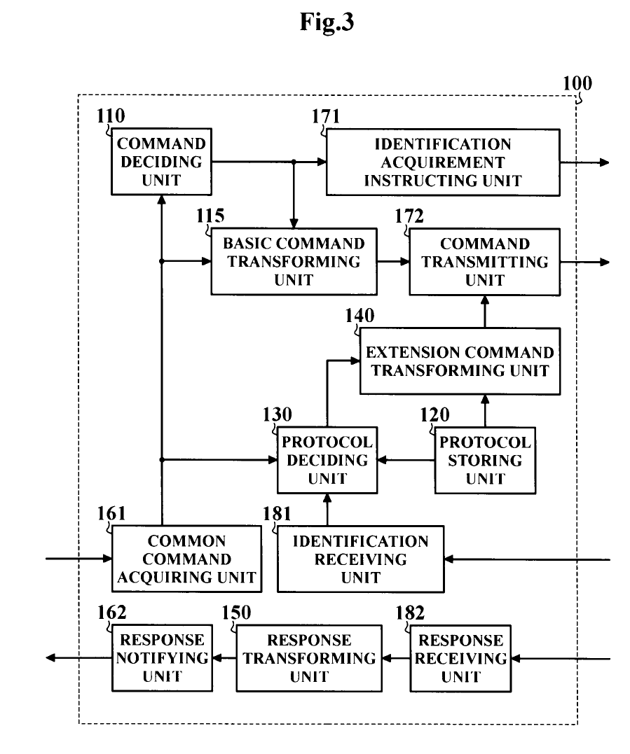

FIG. 3 is the block configuration chart showing one example of the functional block configuration of the RFID reader/writer apparatus 100, in accordance with the present embodiment.

The functional block described below is implemented by the CPU 911 executing programs stored, for example, on the ROM 913. Alternatively, a specialized digital circuit or analog circuit maybe used for the implementation. Especially, it is preferable that a block requiring a high-processing speed is implemented by using the specialized circuit rather than the implementation by using the CPU 911 with a software.

The RFID reader/writer apparatus 100 includes a command deciding unit 110, a basic command transforming unit 115, the protocol storing unit 120, a protocol deciding unit 130, the extension command transforming unit 140, the response transforming unit 150, the common command acquiring unit 161, a response notifying unit 162, an identification acquirement instructing unit 171, a command transmitting unit 172, an identification receiving unit 181, and a response receiving unit 182.

The common command acquiring unit 161, by using the communication apparatus 915, acquires a common command transmitted by the PC 810. The “common command” is a command that indicates the instruction to the IC tag 820 and so forth. The instruction based on the common command is implemented by transforming the common command to one or more commands that the IC tag 820 interprets, by the RFID reader/writer apparatus 100. The common command includes not only a command that can be implemented solely by a function supplied by the basic command, but also includes a command which is required to use a function supplied by the extension command. The common command acquiring unit 161, by using the CPU 911, outputs the acquired common command. For example, an IC tag 820 of the manufacturer A has a memory area of 4096 bytes, treated as 16 blocks of 256 bytes per block. The IC tag 820 of the manufacturer A interprets an extension command “BlockReadA” for reading data from a block as unit by specifying the number of the block between 0 and 15, or it interprets an extension command “BlockWriteA” for writing data into a block as unit by specifying the number of the block between 0 and 15.

In contrast to this, an IC tag 820 of the manufacturer B has a memory area of 6400 bytes, treated as 50 blocks of 128 bytes per block. The IC tag 820 of the manufacturer B interprets an extension command “BlockReadB” for reading data from a block as unit by specifying the number of the block between 1 and 50, or it interprets an extension command “BlockWriteB” for writing data into a block as unit by specifying the number of the block between 1 and 50.

Further, an IC tag 820 of the manufacturer C has a memory area of 8192 bytes, treated as 8 blocks of 1024 bytes per block. The IC tag 820 of the manufacturer C interprets an extension command “BlockReadC” for reading data from a block as unit by specifying the number of the block between 0 and 7, or it interprets an extension command “BlockWriteC” for writing data into a block as unit by specifying the number of the block between 0 and 7.

To overcome the differences in the extension commands of the different manufacturers such as these, the common command, for example, includes a “common block read” command for reading data from a block as unit by specifying a block size and a block number, which of the first block is 0, and a “common block write” command for writing data into a block as unit by specifying a block size and a block number, which of the first block is 0.

The protocol storing unit 120, by using the flash memory 920, stores a protocol table beforehand. The protocol table is a table that indicates a protocol of the extension command unique to each manufacturer.

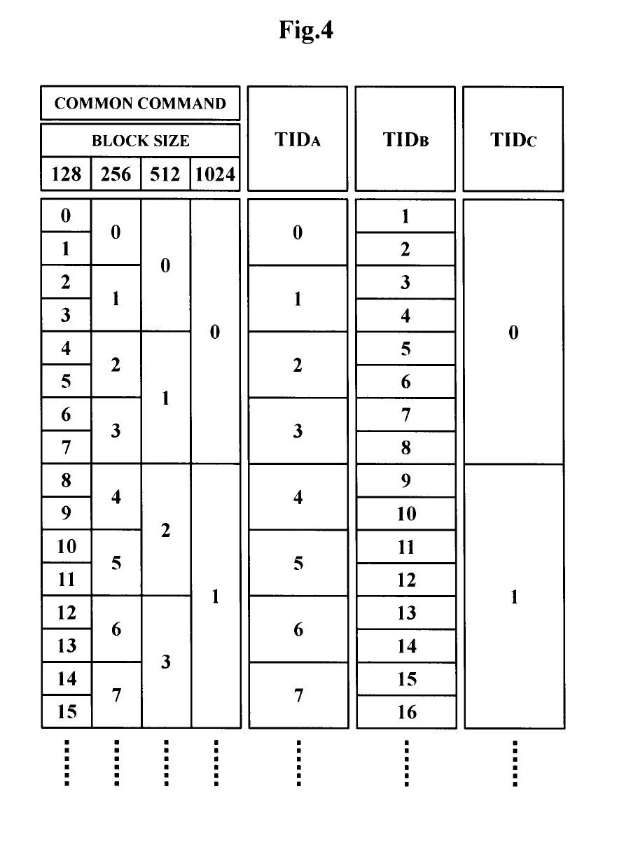

FIG. 4 illustrates the example of correspondences of the block numbers of the block operation commands between the common commands and the extension commands unique to various manufacturers, in accordance with the present embodiment.

In this example, there are three types of the IC tags. The manufacturer A produces an IC tag with a TID serving as “TID_{A}”. The manufacturer B produces an IC tag with a TID serving as “TID_{B}”. The manufacturer C produces an the IC tag with a TID serving as “TID_{C}”. The three types of the IC tags interpret different extension commands .

In the case that a block size is specified as “128”, since a block size of the extension command that the IC tag with the TID serving as TID_{A} interprets (hereinafter referred to as the “extension command A”) is 256, therefore, block numbers 0 and 1 of the common command correspond to a block number 0 of the extension command A. Since a block size of the extension command that the IC tag with the TID serving as TID_{B} interprets (hereinafter referred to as the “extension command B”) is 128 but a start number is 1, a block number 0 of the common command corresponds to a block number 1 of the extension command B. Since a block size of the extension command that the IC tag with the TID serving as TID_{C} interprets (hereinafter referred to as the “extension command C”) is 1024, therefore, block numbers 0 to 7 of the common command correspond to a block number 0 of the extension command of the manufacturer C.

In the case that a block size is specified as “512”, the block number 0 of the common command corresponds to block numbers 0 and 1 of the extension command A, and corresponds to block numbers 1 to 4 of the extension command B. Also, the block numbers 0 and 1 of the common command correspond to the block number 0 of the extension command C.

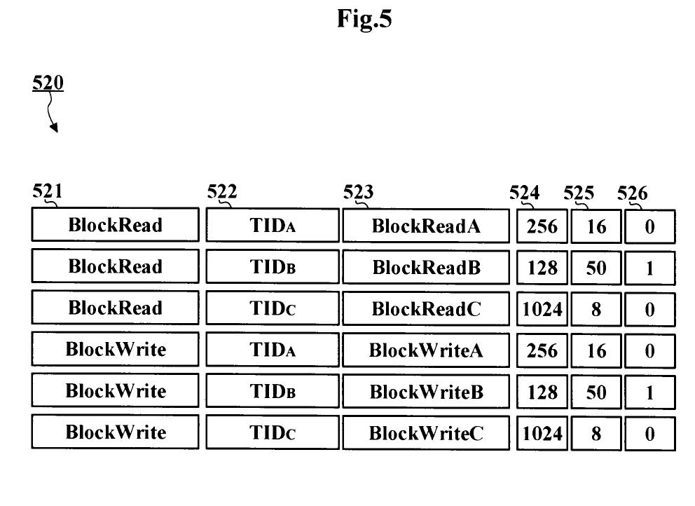

FIG. 5 illustrates one example of the protocol table 520 stored by the protocol storing unit 120, in accordance with the present embodiment.

The protocol table 520, for example, has a plurality of data sets (records), each of which includes a common command 521, a protocol 522, an extension command 523, a block size 524, a block amount 525, and a start block number 526.

The common command 521 indicates a common command that corresponds to a function supplied by the extension command.

The protocol 522 is a data that indicates the a group of the extension commands that the IC tag 820 interprets, for example, it is the TID of the IC tag 820. Alternatively, the protocol 522 can be an identification information that indicates the manufacturer of the IC tag 820. The identification information that indicates the manufacturer of the IC tag can be extracted by masking a portion other than a portion indicating the manufacturer of the IC tag, among the TID of the IC tag 820.

The extension command 523 indicates an extension command that is extended uniquely by each manufacturer. The block size 524 indicates a size of the memory area that can be operated by a single command, when the extension command is serving as the block operation command. The block amount 525 indicates a total number of blocks of the memory area that can be operated by the block operation command. The start block number 526 indicates a block number of the first block.

In the case that the first block number is “0” regardless of the types of the IC tag, the protocol table 520 does not need the start block number 526.

Referring back to FIG. 3, an explanation of the functional block of the RFID reader/writer apparatus 100 will follow below. The command deciding unit 110, by using the CPU 911, inputs a common command outputted by the common command acquiring unit 161. The command deciding unit 110, by using the CPU 911, decides whether the inputted common command is a command that can be performed by just a function supplied by the basic command, or the command needs using a function supplied by the extension command. The command deciding unit 110, by using the CPU 911, outputs the decided result.

The basic command transforming unit 115, by using the CPU 911, inputs the decided result outputted by the command deciding unit 110. When the decision of the command deciding unit 110, according to the decided result inputted, is that the common command acquired by the common command acquiring unit 161 is a command that can be performed by the basic command, the basic command transforming unit 115, by using the CPU 911, inputs the common command outputted by the common command acquiring unit 161. The basic command transforming unit 115, by using the CPU 911, transforms the inputted common command, into one or more basic commands. The basic command transforming unit 115, by using the CPU 911, outputs the transformed basic commands.

The identification acquirement instructing unit 171, by using the CPU 911, inputs the decided result outputted by the command deciding unit 110. When the decision of the command deciding unit 110, according to the decided result inputted, is that the common command acquired by the common command acquiring unit 161 is a command that needs using the extension command, the identification acquirement instructing unit 171 transmits an identification acquiring command to the IC tag 820, by using the transmitting apparatus 917. The identification acquiring command is a command that instructs to transmit the TID (tag ID, a example of the identification information) to the IC tag 820. For example, it is a combination of the basic commands such as “Select command”, “Query command”, “Ack command”, “ReqRN command” (acquisition of handle number), and “Read command” (reading). Accordingly, the IC tag 820 can interpret the identification acquiring command regardless of the manufacturers of the IC tags 820.

The identification receiving unit 181, by using the receiving apparatus 918, receives a TID transmitted by the IC tag 820, as a response to the identification acquiring command transmitted by the identification acquirement instructing unit 171. The identification receiving unit 181, by using the CPU 911, outputs the received TID.

The protocol deciding unit 130 (one example of the commands deciding unit), by using the CPU 911, inputs a TID outputted by the identification receiving unit 181. The protocol deciding unit 130, by using the CPU 911, acquires the inputted TID as a protocol of the IC tag 820. Alternatively, the protocol deciding unit 130, by using the CPU 911, acquires the identification information that indicates the manufacturer of the IC tag 820 from the TID.

The protocol deciding unit 130, by using the CPU 911, inputs the common command outputted by the common command acquiring unit 161. The protocol deciding unit 130, based on the acquired protocol and the inputted common command, searches through the protocol table 520 stored by the protocol storing unit 120 for a record meeting the conditions: its common command 521 matches the inputted common command, and also its protocol 522 matches the acquired protocol. The protocol deciding unit 130 acquires the extension command 523, the block size 524, the block amount 525 and the start block number 526. The protocol deciding unit 130, by using the CPU 911, outputs the inputted common command, the acquired protocol, and the extension command 523, the block size 524, the block amount 525 and the start block number 526 acquired from the record.

The extension command transforming unit 140, by using the CPU 911, inputs the common command, the protocol, the extension command 523, the block size 524, the block amount 525, and the start block number 526, which are outputted by the protocol deciding unit 130. The extension command transforming unit 140, by using the CPU 911, transforms the inputted common command to the extension command of the inputted protocol. The extension command transforming unit 140, by using the CPU 911, outputs the transformed extension command.

The command transmitting unit 172, by using the CPU 911, inputs the decided result outputted by the command deciding unit 110. When the decision of the command deciding unit 110, according to the decided result inputted, is that the common command acquired by the common command acquiring unit 161 is a command that can be performed by a basic command, the command transmitting unit 172, inputs the basic command outputted by the basic command transforming unit 115. When the decision of the command deciding unit 110, according to the decided result inputted, is that the common command acquired by the common command acquiring unit 161 is a command that needs using an extension command, the command transmitting unit 172, by using the CPU 911, inputs the extension command outputted by the extension command transforming unit 140.

The command transmitting unit 172, by using the transmitting apparatus 917, transmits the inputted command to the IC tag 820.

The response receiving unit 182, by using the receiving apparatus 918, receives a data (hereinafter referred to as the “response data”) transmitted by the IC tag 820, as a response to a command transmitted by the command transmitting unit 172. When a command transmitted by the command transmitting unit 172 is a read command, the response data, for example, is the data read from the memory area. Alternatively, when a command transmitted by the command transmitting unit 172 is a write command, the response data, for example, is a status data which indicates whether the write is successful or not. The response receiving unit 182, by using the CPU 911, outputs the received response data.

The response transforming unit 150, by using the CPU 911, when the protocol deciding unit 130 outputs the common command and the like, inputs the common command, the protocol, the extension command 523, the block size 524, the block amount 525 and the start block number 526, which are outputted by the protocol deciding unit 130.

The response transforming unit 150, by using the CPU 911, inputs the response data outputted by the response receiving unit 182. The response transforming unit 150, by using the CPU 911, transforms a format of the response data into a prescribed format which is predetermined as a response to the common command. The response transforming unit 150, by using the CPU 911, outputs the response data transformed (hereinafter referred to as the “transformed data”).

The response notifying unit 162, by using the CPU 911, inputs the transformed data outputted by the response transforming unit 150. The response notifying unit 162, by using the CPU 911, notifies the PC 810 of the inputted transformed data as a response to the common command acquired by the common command acquiring unit 161.

Next, a detail of the operation is described by illustrating several examples of the specific commands.

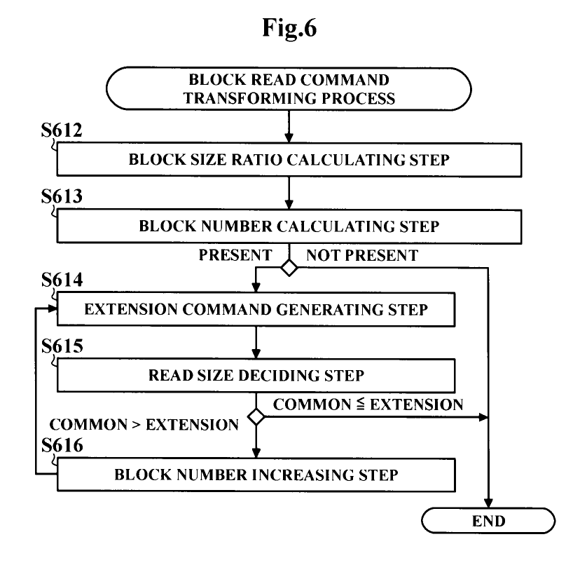

FIG. 6 is the flowchart showing one example of the flow of the block read command transforming process in which the extension command transforming unit 140 of the present embodiment transforms the block read command.

The extension command transforming unit 140 performs the block read command transforming process when the inputted common command is the block read command.

The block read command transforming process, for example, includes a block size ratio calculating step S612, a block number calculating step S613, an extension command generating step S614, a read size deciding step S615, and a block number increasing step S616.

In the block size ratio calculating step S612, the extension command transforming unit 140, by using the CPU 911, calculates a ratio of the block size specified in the inputted common command divided by the inputted block size 524.

In the block number calculating step S613, the extension command transforming unit 140, by using the CPU 911, calculates a product of the block number specified in the inputted common command and the ratio calculated in the block size ratio calculating step S612. The extension command transforming unit 140, by using the CPU 911, compares the calculated product with the inputted block amount 525. When the calculated product is greater than or equal to the block amount 525, that block is not present in the IC tag 820. Therefore, the extension command transforming unit 140, by using the CPU 911, ends the block read command transforming process.

When the calculated product is less than the block amount 525, the extension command transforming unit 140, by using the CPU 911, calculates a sum of the calculated product and the inputted start block number 526, to obtain it as a block number.

In the extension command generating step S614, the extension command transforming unit 140, by using the CPU 911, based on the inputted extension command 523 and the block number calculated in the block number calculating step S613, generates the transformed extension command. The extension command transforming unit 140, by using the CPU 911, outputs the generated extension command.

In the read size deciding step S615, the extension command transforming unit 140, by using the CPU 911, compares a block size specified in the inputted common command with a total sum of the block sizes of the extension commands generated in the extension command generating step S614.

When the block size specified in the inputted common command is less than or equal to the total sum of the block sizes of the extension commands, the extension command transforming unit 140, by using the CPU 911, ends the block read command transforming process.

When the block size specified in the inputted common command is greater than the total sum of the block sizes of the extension commands, then the extension command transforming unit 140 proceeds to a block number increasing step S616.

In the block number increasing step S616, the extension command transforming unit 140, by using the CPU 911, calculates a sum of the block number calculated in the block number calculating step S613 and 1, to obtain it as a new block number.

After that, the extension command transforming unit 140 returns to the extension command generating step S614.

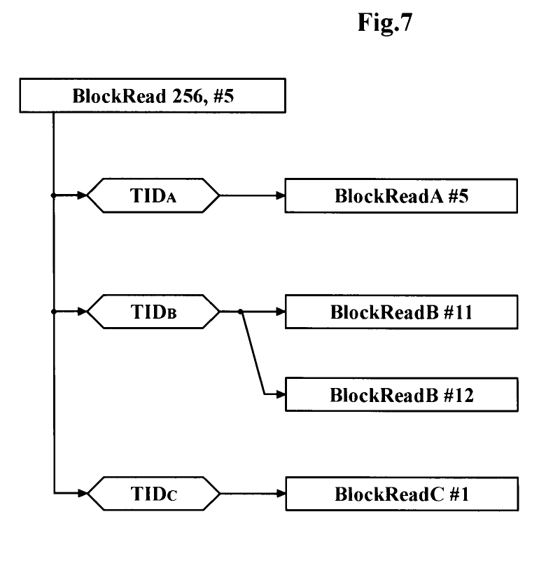

FIG. 7 illustrates the specific example of the relation between the common command acquired by the common command acquiring unit 161 and the extension command transformed by the extension command transforming unit 140, in accordance with the present embodiment.

For example, the common command inputted by the common command acquiring unit 161 serves as the block read command that instructs reading of a fifth block, by specifying 256 bytes as one block. Also, the protocol storing unit 120 stores the protocol table 520 shown in FIG. 5.

In the case that a protocol decided by the protocol deciding unit 130 from the TID received by the identification receiving unit 181 is, for example, “TID_{A}”, the extension command transforming unit 140, by using the CPU 911, inputs a common command 521 “BlockRead”, a protocol “TID_{A}”, an extension command 523 “BlockReadA”, a block size 524 “256”, a block amount 525 “16”, and a start block number 526 “0”, which are outputted by the protocol deciding unit 130.

In the block size ratio calculating step S612, the extension command transforming unit 140, by using the CPU 911, calculates a ratio “1” between the block size “256” specified in the inputted common command and the inputted block size 524 “256”.

In the block number calculating step S613, the extension command transforming unit 140, by using the CPU 911, calculates a product “5” between the block number “5” specified in the inputted common command and the calculated ratio “1”. The extension command transforming unit 140, by using the CPU 911, decides that the calculated product “5” is less than the inputted block amount 525 “16”. The extension command transforming unit 140, by using the CPU 911, adds the calculated product “5” and the inputted start block number 526 “0”, to work out a block number “5”.

In the extension command generating step S614, the extension command transforming unit 140, by using the CPU 911, generates and outputs the extension command “BlockReadA #5”, based on the inputted extension command 523 “BlockReadA” and the calculated block number “5”.

In the read size deciding step S615, the extension command transforming unit 140, by using the CPU 911, decides that the block size “256” specified in the inputted common command is not over the total sum “256” of the block size of the generated extension command, and ends the block read command transforming process.

In the case that a protocol decided by the protocol deciding unit 130 from TID received by the identification receiving unit 181 is, for example, “TID_{B}”, the extension command transforming unit 140, by using the CPU 911, inputs the common command 521 “BlockRead”, a protocol “TID_{B}”, an extension command 523 “BlockReadB”, a block size 524 “128”, a block amount 525 “50”, and a start block number 526 “1”, which are outputted by the protocol deciding unit 130.

In the block size ratio calculating step S612, the extension command transforming unit 140, by using the CPU 911, calculates a ratio “2” between the block size “256” specified in the inputted common command and the inputted block size 524 “128”.

In the block number calculating step S613, the extension command transforming unit 140, by using the CPU 911, calculates a product “10” between the block number “5” specified in the inputted common command and the calculated ratio “2”. The extension command transforming unit 140, by using the CPU 911, decides that the calculated product “10” is less than the inputted block amount 525 “50”. The extension command transforming unit 140, by using the CPU 911, adds the calculated product “10” and the inputted start block number 526 “1”, to workout a block number “11”.

In the extension command generating step S614, the extension command transforming unit 140, by using the CPU 911, generates the extension command “BlockReadB #11”, based on the inputted extension command 523 “BlockReadB” and the calculated block number “11”.

In the read size deciding step S615, the extension command transforming unit 140, by using the CPU 911, decides that the block size “256” specified in the inputted common command is greater than the total sum “128” of the block size of the generated extension command, and the process advances to the block number increasing step S616.

In the block number increasing step S616, the extension command transforming unit 140, by using the CPU 911, adds 1 to the calculated block number “11”, to work out the block number “12”.

In the extension command generating step S614, the extension command transforming unit 140, by using the CPU 911, generates and outputs the extension command “BlockReadB #12”, based on the inputted extension command 523 “BlockReadB” and the calculated block number “12”.

In the read size deciding step S615, the extension command transforming unit 140, by using the CPU 911, decides that the block size “256” specified in the inputted common command is not over the total sum “256” of the block sizes of the generated extension commands, and ends the block read command transforming process.

In the case that a protocol decided by the protocol deciding unit 130 from the TID received by the identification receiving unit 181 is, for example, “TID_{C}”, the extension command transforming unit 140, by using the CPU 911, inputs a common command 521 “BlockRead”, a protocol “TID_{C}”, an extension command 523 “BlockReadC”, a block size 524 “1024”, a block amount 525 “8”, and a start block number 526 “0”, which are outputted by the protocol deciding unit 130.

In the block size ratio calculating step S612, the extension command transforming unit 140, by using the CPU 911, calculates a ratio “1/4” between the block size “256” specified in the inputted common command and the inputted block size 524 “1024”.

In the block number calculating step S613, the extension command transforming unit 140, by using the CPU 911, calculates a product “5/4” of the block number “5” specified in the inputted common command and the calculated ratio “1/4”, and cut off the fractional part to get “1”. The extension command transforming unit 140, by using the CPU 911, decides that the calculated product “1” is less than the inputted block amount 525 “8”. The extension command transforming unit 140, by using the CPU 911, adds the calculated product “1” and the inputted start block number 526 “0”, and calculates a block number “1”.

In the extension command generating step S614, the extension command transforming unit 140, by using the CPU 911, generates and outputs the extension command “BlockReadC #1”, based on the inputted extension command 523 “BlockReadC” and the calculated block number “1”.

In the read size deciding step S615, the extension command transforming unit 140, by using the CPU 911, decides that the block size “256” specified in the inputted common command is not over the total sum “1024” of the block size of the generated extension command, and ends the block read command transforming process.

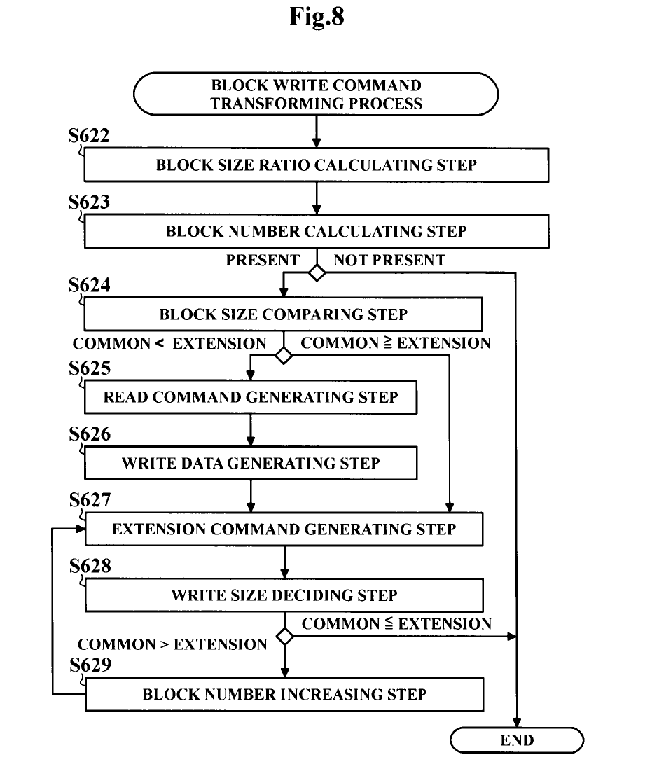

FIG. 8 is the flow chart showing one example of the flow of the block write command transforming process in which the extension command transforming unit 140 of the present embodiment transforms the block write command.

The extension command transforming unit 140 performs the block write command transforming process, when the inputted common command is serving as the block write command.

The block write command transforming process, for example, includes a block size ratio calculating step S622, a block number calculating step S623, a block size comparing step S624, a read command generating step S625, a write data generating step S626, an extension command generating step S627, a write size deciding step S628, and a block number increasing step S629.

In the block size ratio calculating step S622, the extension command transforming unit 140, by using the CPU 911, calculates a ratio of the block size specified in the inputted common command divided by the inputted block size 524.

In the block number calculating step S623, the extension command transforming unit 140, by using the CPU 911, calculates a product of the block number specified in the inputted common command and the ratio calculated in the block size ratio calculating step S622. The extension command transforming unit 140, by using the CPU 911, compares the calculated product with the inputted block amount 525. When the calculated product is greater than or equal to the inputted block number 525, that block is not present in the IC tag 820. Therefore, the extension command transforming unit 140, by using the CPU 911, ends the block write command transforming process.

When the calculated product is less than the inputted block amount 525, the extension command transforming unit 140, by using the CPU 911, calculates a sum of the calculated product and the inputted start block number 526, to obtain it as a block number.

In the block size comparing step S624, the extension command transforming unit 140, by using the CPU 911, compares the block size specified in the inputted common command with the inputted block size 524. The extension command transforming unit 140, by using the CPU 911, when the block size specified in the common command is greater than or equal to the inputted block size 524, the process advances to the extension command generating step S627.

Meanwhile, the extension command transforming unit 140, by using the CPU 911, based on whether or not the ratio calculated in the block size ratio calculating step S622 is greater than or equal to 1, may decide whether or not the block size specified in the common command is greater than or equal to the inputted block size 524.

In the read command generating step S625, the extension command transforming unit 140, by using the CPU 911, generates the extension command of the inputted protocol. The extension command generated here is the block read command for reading from the IC tag 820 a portion of the data not to be rewritten, upon writing data to the block.

The extension command transforming unit 140, by using the CPU 911, searches through the protocol table 520 stored by the protocol storing unit 120 for a record meeting the conditions: its common command 521 matches the “BlockRead”, and also its protocol 522 matches the inputted protocol. The extension command transforming unit 140 acquires the extension command 523 from the record. The extension command transforming unit 140, by using the CPU 911, generates the extension command based on the acquired extension command 523 and the calculated block number in the block number calculating step S623.

In the write data generating step S626, the extension command transforming unit 140, by using the CPU 911, inputs a response data received and outputted by the response receiving unit 182, which is transmitted by the IC tag 820 as a response to the extension command generated in the read command generating step S625. The extension command transforming unit 140, by using the CPU 911, writes the write data specified in the inputted common command over a portion of the inputted response data, to be written as instructed by the inputted common command, to generate write data.

In the extension command generating step S627, the extension command transforming unit 140, by using the CPU 911, generates the transformed extension command, based on the inputted extension command 523, the block number calculated in the block number calculating step S623, and the write data. The extension command transforming unit 140, by using the CPU 911, outputs the generated extension command.

In the write size deciding step S628, the extension command transforming unit 140, by using the CPU 911, compares the block size specified in the inputted common command with the total sum of the block sizes of the extension commands generated in the extension command generating step S627.

When the block size specified in the inputted common command is less than or equal to the total sum of the block sizes of the extension commands, the extension command transforming unit 140, by using the CPU 911, ends the block write command transforming process.

When the block size specified in the inputted common command is greater than the total block size of the extension command, the extension command transforming unit 140 proceeds to the block number increasing step S629.

In the block number increasing step S629, the extension command transforming unit 140, by using the CPU 911, calculates a sum of the block number calculated in the block number calculating step S623 and 1, to obtain it as a new block number.

After that, the extension command transforming unit 140 returns to the extension command generating step S627.

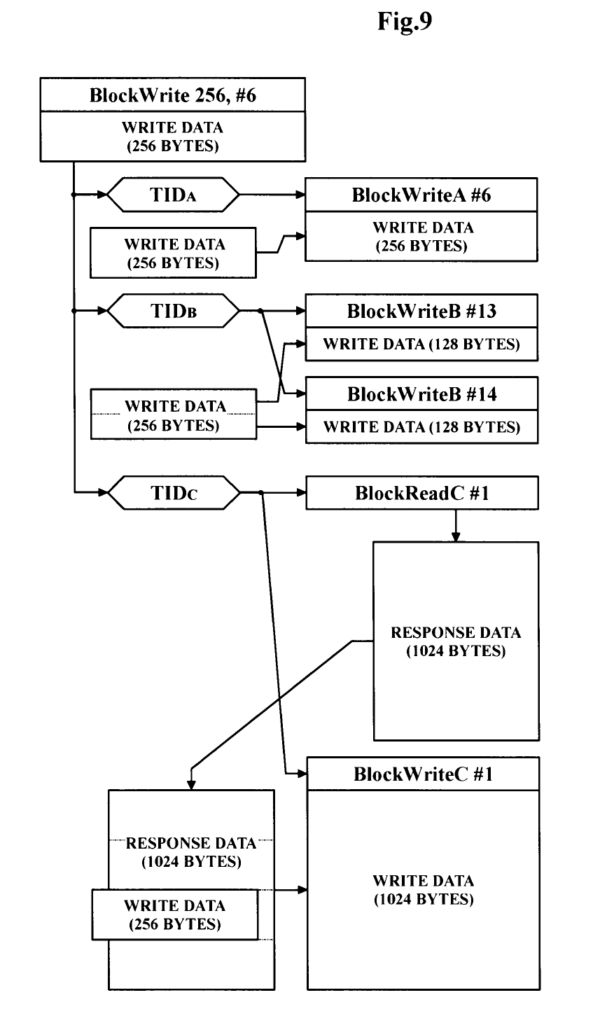

FIG. 9 illustrates the specific example of the relation between the common command acquired by the common command acquiring unit 161 and the extension command transformed by the extension command transforming unit 140, in accordance with the present embodiment.

For example, the common command inputted by the common command acquiring unit 161 serves as the block write command which instructs writing to a sixth block, by specifying 256 bytes as one block. Also, the protocol storing unit 120 stores the protocol table 520 shown in FIG. 5.

In the case that a protocol decided by the protocol deciding unit 130 from the TID received by the identification receiving unit 181 is, for example, “TID_{A}”, the extension command transforming unit 140, by using the CPU 911, inputs a common command “BlockWrite”, a protocol “TID_{A}”, an extension command 523 “BlockWriteA”, a block size 524 “256”, a block amount 525 “16”, and a start block number 526 “0”, which are outputted by the protocol deciding unit 130.

In the block size ratio calculating step S622, the extension command transforming unit 140, by using the CPU 911, calculates a ratio “1” between the block size “256” specified in the inputted common command and the inputted block size 524 “256”.

In the block number calculating step S623, the extension command transforming unit 140, by using the CPU 911, calculates a product “6” between the block number “6” specified in the inputted common command and the calculated ratio “1”. The extension command transforming unit 140, by using the CPU 911, decides that the calculated product “6” is less than the inputted block amount 525 “16”. The extension command transforming unit 140, by using the CPU 911, adds the calculated product “6” and the inputted start block number 526 “0”, to work out a block number “6”.

In the block size comparing step S624, the extension command transforming unit 140 decides that the block size “256” specified in the inputted common command is not less than the inputted block size 524 “256”.

In the extension command generating step S627, the extension command transforming unit 140, by using the CPU 911, generates and outputs the extension command “BlockWriteA #6”, based on the inputted extension command 523 “BlockWriteA”, the calculated block number “6”, and 256 bytes of the write data specified in the inputted common command.

In the write size deciding step S628, the extension command transforming unit 140, by using the CPU 911, decides that the block size “256” specified in the inputted common command is not over the total sum “256” of the block size of the generated extension command, and ends the block write command transforming process.

In the case that a protocol decided by the protocol deciding unit 130 from the TID received by the identification receiving unit 181 is, for example, “TID_{B}”, the extension command transforming unit 140, by using the CPU 911, inputs a common command “BlockWrite”, a protocol “TID_{B}”, an extension command 523 “BlockWriteB”, a block size 524 “128”, a block amount 525 “50”, and a start block number 526 “1”, that are outputted by the protocol deciding unit 130.

In the block size ratio calculating step S622, the extension command transforming unit 140, by using the CPU 911, calculates a ratio “2” between the block size “256” specified in the inputted common command and the inputted block size 524 “128”.

In the block number calculating step S623, the extension command transforming unit 140, by using the CPU 911, calculates a product “12” of the block number “6” specified in the inputted common command and the calculated ratio “2”. The extension command transforming unit 140, by using the CPU 911, decides that the calculated product “12” is less than the inputted block amount 525 “50”. The extension command transforming unit 140, by using the CPU 911, adds the calculated product “12” and the inputted start block number 526 “1”, to work out a block number “13”.

In the block size comparing step S624, the extension command transforming unit 140, by using the CPU 911, decides that the block size “256” specified in the inputted common command is not less than the inputted block size 524 “128”.

In the extension command generating step S627, the extension command transforming unit 140, by using the CPU 911, generates and outputs the extension command “BlockWriteB #13”, based on the inputted extension command 523 “BlockWriteB”, the calculated block number “13”, and the first 128 bytes of the 256 bytes of the write data specified in the inputted common command.

In the write size deciding step S628, the extension command transforming unit 140, by using the CPU 911, decides that the block size “256” specified in the inputted common command is greater than the total sum “128” of the block size of the generated extension command, and the process advances to the block number increasing step S629.

In the block number increasing step S629, the extension command transforming unit 140, by using the CPU 911, adds 1 to the calculated block number “13”, to work out a block number “14”.

In the extension command generating step S627, the extension command transforming unit 140, by using the CPU 911, generates and outputs the extension command “BlockWriteB #14”, based on the inputted extension command 523 “BlockWriteB”, the calculated block number “14”, and the remaining 128 bytes of the 256 bytes of the write data specified in the inputted common command.

In the write size deciding step S628, the extension command transforming unit 140, by using the CPU 911, decides that the block size “256” specified in the inputted common command is not over the total sum “256” of the block sizes of the generated extension commands, and ends the block write command transforming process.

In the case that a protocol decided by the protocol deciding unit 130 from the TID received by the identification receiving unit 181 is, for example, “TID_{C}”, the extension command transforming unit 140, by using the CPU 911, inputs a common command “BlockWrite”, a protocol “TID_{C}”, an extension command 523 “BlockWriteC”, a block size 524 “1024”, a block amount 525 “8”, and a start block number 526 “0”, that are outputted by the protocol deciding unit 130.

In the block size ratio calculating step S622, the extension command transforming unit 140, by using the CPU 911, calculates a ratio “1/4” between the block size “256” specified in the inputted common command and the inputted block size 524 “1024”.

In the block number calculating step S623, the extension command transforming unit 140, by using the CPU 911, calculates a product “3/2” of the block number “6” specified in the inputted common command and the calculated ratio “1/4”, and cuts off the fractional part, to get “1”. The extension command transforming unit 140, by using the CPU 911, decides that the product “1” that has discarded the fractional part is less than the inputted block amount 525 “8”. The extension command transforming unit 140, by using the CPU 911, adds the calculated product “1” and the inputted start block number 526 “0”, to work out a block number In the block size comparing step S624, the extension command transforming unit 140, by using the CPU 911, decides that the block size “256” specified in the inputted common command is less than the inputted block size 524 “1024”.

In the read command generating step S625, the extension command transforming unit 140, by using the CPU 911, searches through the protocol table 520 stored by the protocol storing unit 120 for a record meeting the conditions: the common command 521 is “BlockRead”, and also the protocol 522 is “TID_{C}”. The extension command transforming unit 140 acquires the extension command 523 “BlockReadC”. The extension command transforming unit 140, by using the CPU 911, generates and outputs the extension command “BlockReadC #1”, based on the acquired extension command 523 “BlockReadC” and the calculated block number “1”.

In the write data generating step S626, the extension command transforming unit 140, by using the CPU 911, inputs 1024 bytes of the data transmitted by the IC tag 820, as a response to the generated extension command “BlockReadC #1”. The extension command transforming unit 140, by using the CPU 911, picks the fractional part only out of the product “3/2” calculated in the block number calculating step S623 to get “1/2”. The extension command transforming unit 140, by using the CPU 911, writes the write data specified in the inputted common command over 256 bytes out of the 1024 bytes of the inputted data, starting from 513th bytes and ending at 758th bytes, which corresponds to “1/21” position, to generate 1024 bytes of write data.

In the extension command generating step S627, the extension command transforming unit 140, by using the CPU 911, generates and outputs the extension command “BlockWriteC #1”, based on the inputted extension command 523 “BlockWriteC”, the calculated block number “1”, and the generated 1024 bytes of the write data.

In the write size deciding step S628, the extension command transforming unit 140, by using the CPU 911, decides that the block size “256” specified in the inputted common command is not over the total sum “1024” of the block size of the extension command generated in the extension command generating step S627, and ends the block write command transforming process.

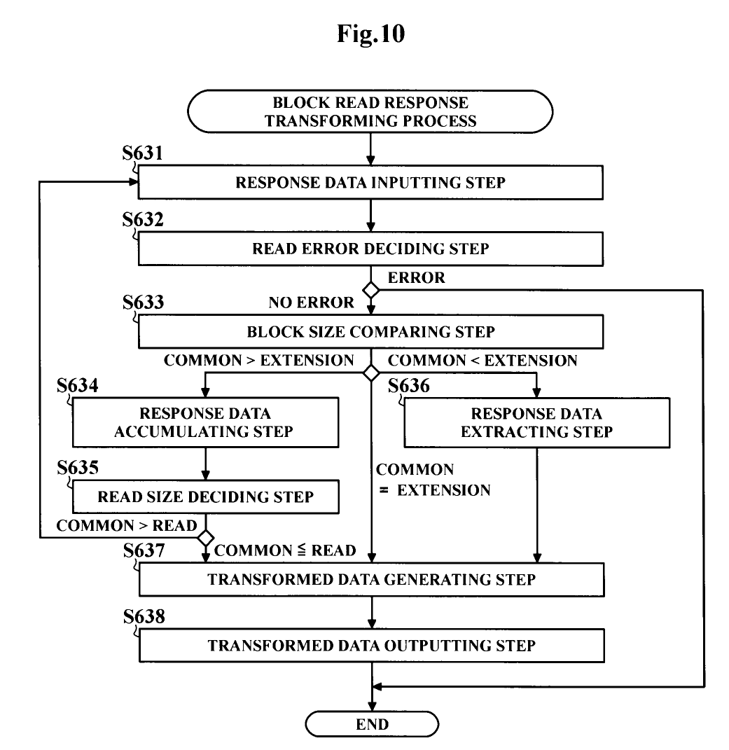

FIG. 10 is the flow chart showing one example of the flow of the block read response transforming process in which the response transforming unit 150 of the present embodiment transforms the response to the block read command.

The response transforming unit 150 performs the block read response transforming process, when the inputted common command is serving as the block read command.

The block read response transforming process, for example, includes a response data inputting step S631, a read error deciding step S632, a block size comparing step S633, a response data accumulating step S634, a read size deciding step S635, a response data extracting step S636, a transformed data generating step S637, and a transformed data outputting step S638.

In the response data inputting step S631, the response transforming unit 150, by using the CPU 911, inputs the response data outputted by the response receiving unit 182.

In the read error deciding step S632, the response transforming unit 150, by using the CPU 911, analyzes the response data inputted in the response data inputting step S631, and decides whether the read error exists or not. The response transforming unit 150, for example, by using the CPU 911, checks for an error detecting code of the inputted response data, and decides whether the read error exists or not.

When deciding that the read error exists, the response transforming unit 150, by using the CPU 911, ends the block read response transforming process.

When deciding that the read error does not exist, the response transforming unit 150, by using the CPU 911, proceeds to the block size comparing step S633.

Meanwhile, the configuration may be as below. When deciding that the read error exists, the response transforming unit 150, by using the CPU 911, generates and outputs the data indicating that the read error exists. Alternatively, the command transmitting unit 172 retransmits the extension command to the IC tag 820, and to the response receiving unit 182 receives the response data again.

In the block size comparing step S633, the response transforming unit 150, by using the CPU 911, compares the block size specified in the inputted common command with the inputted block size 524.

When deciding that the block size specified in the inputted common command is greater than the inputted block size 524, the response transforming unit 150, by using the CPU 911, proceeds to the response data accumulating step S634.

When deciding that the block size specified in the inputted common command is less than the inputted block size 524, the response transforming unit 150, by using the CPU 911, proceeds to the response data extracting step S636.

When deciding that the block size specified in the inputted common command is equal to the inputted block size 524, the response transforming unit 150, by using the CPU 911, regards the response data inputted in the response data inputting step S631 as the data prior to transformation, and proceeds to the transformed data generating step S637.

In the response data accumulating step S634, the response transforming unit 150, by using the CPU 911, accumulates the response data inputted in the response data inputting step S631.

In the read size deciding step S635, the response transforming unit 150, by using the CPU 911, compares the block size specified in the common command with the total sum of the sizes of the response data accumulated in the response data accumulating step S634.

When deciding that the block size specified in the inputted common data is greater than the total sum of the sizes of the accumulated response data, the response transforming unit 150, by using the CPU 911, returns to the response data inputting step S631.

When deciding that the block size specified in the inputted common data is less than or equal to the total sum of the sizes of the accumulated response data, the response transforming unit 150, by using the CPU 911, regards the accumulated response data as the data prior to transformation, and proceeds to the transformed data outputting step S637.

In the response data extracting step S636, the response transforming unit 150, by using the CPU 911, extracts a portion to be outputted, from the response data inputted in the response data inputting step S631, to obtain it as the data prior to transformation.

For example, the response transforming unit 150, by using the CPU 911, calculates a quotient obtained from dividing the inputted block size 524 by the block size specified in the inputted common command. The response transforming unit 150, by using the CPU 911, calculates a remainder obtained from dividing the block number specified in the inputted common command by the calculated quotient. The response transforming unit 150, by using the CPU 911, divides the inputted response data by each block size specified in the inputted common command. The response transforming unit 150, by using the CPU 911, selects a “calculated remainder+1”th response data, from the divided response data, as the data prior to transformation.

In the transformed data generating step S637, the response transforming unit 150, by using the CPU 911, transforms the data prior to transformation into a prescribed format, to generate the transformed data.

In the transformed data outputting step S638, the response transforming unit 150, by using the CPU 911, outputs the transformed data.

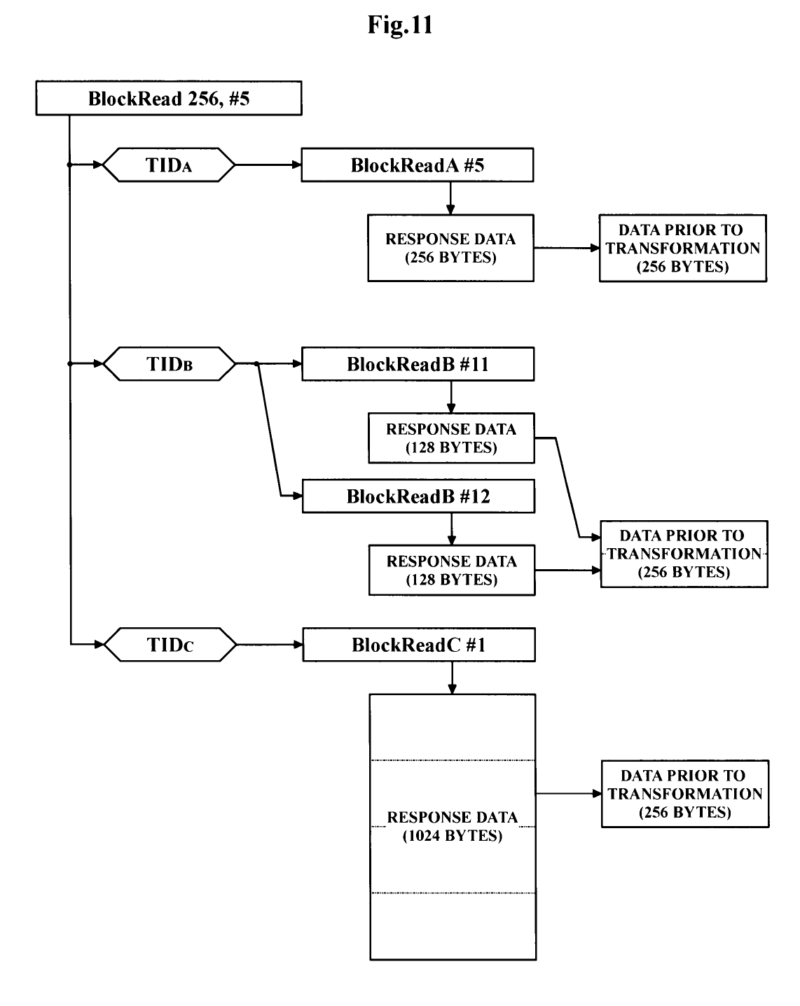

FIG. 11 illustrates the specific example of the relation between the response data received by the response receiving unit 182 and the transformed data transformed by the response transforming unit 150, in accordance with the present embodiment.

In the case that the extension command transforming unit 140 transforms the common command “BlockRead 256, #5” for reading the fifth block by setting 256 bytes as a single block, into the extension command “BlockReadA #5” for reading the fifth block by setting 256 bytes as a single block, the IC tag 820 transmits the 256 bytes of the data read as its response data. The response transforming unit 150, by using the CPU 911, regards the response data received by the response receiving unit 182 as the data prior to transformation, and transforms the data prior to transformation into a prescribed format to get the transformed data.

In the case that the extension command transforming unit 140 transforms the common command “BlockRead 256, #5” into the extension command “BlockReadB #11” for reading the eleventh block and the extension command “Block ReadB #12” for reading the twelfth block by setting 128 bytes as a single block, the IC tag 820 transmits the 128 bytes of the data read as the response data to the “BlockReadB #11”, and transmits the 128 bytes of the data read as the response data to the “BlockReadB #12”. The response transforming unit 150, by using the CPU 911, accumulates and combines two response data received by the response receiving unit 182 to generate 256 bytes of the data as the data prior to transformation, and transforms the data prior to transformation into a prescribed format to get the transformed data.

In the case that the extension command transforming unit 140 transforms the common command “BlockRead 256, #5” into the extension command “BlockReadC #1” for reading the first block by setting 1024 bytes as a single block, then the IC tag 820 transmits the 1024 bytes of the data read as the response data. The response transforming unit 150, by using the CPU 911, extracts 256 bytes of the data corresponding to a fifth block from the response data received by the response receiving unit 182 as the data prior to transformation, and transforms the data prior to transformation into a prescribed format to get the transformed data.

According to the above explanations, the case has been described in which there is only one kind of “block read command” or “block write command” present in the single protocol. However, there are also cases in which there are plural kinds of “block read commands” or “block write commands” present in the single protocol. For example, a protocol may include a block read command “BlockReadSmall” where the block size is 256 bytes, and a block read command “BlockReadLarge” where the block size is 1024 bytes.

In such cases, the extension command transforming unit 140, by using the CPU 911, transforms the inputted common command “BlockRead” into an extension command having a better efficiency. For example, when the block size specified in the common command is less than or equal to 512 bytes, the extension command transforming unit 140 transforms it into the extension command “BlockReadSmall”. If transforming into the extension command “BlockReadLarge”, the communication time gets longer due to reading of 1024 bytes, and more than 512 bytes out of the read data becomes useless. In reverse, when the block size specified in the common command “BlockRead” is greater than 512 bytes, the extension command transforming unit 140 transforms it into the extension command “BlockReadLarge”. If transforming it into the extension command “BlockReadSmall”, the commands are transmitted to the IC tag 820 three times or more. Therefore, it takes time to transmit the commands and to receive the responses, and the communication time gets longer adversely.

Meanwhile, “block read command” and “block write command” have been described in the above explanations, but the common command and the extension command are not limited to these, but they may be the commands that implement other functions.

The data operation apparatus (the RFID reader/writer apparatus 100) of the present embodiment communicates to a storage apparatus (the IC tag 820) according to the instruction from the control apparatus (the PC 810), and operates the data stored by the storage apparatus (the IC tag 820).

The data operation apparatus (the RFID reader/writer apparatus 100) includes the processing apparatus for processing data (the CPU 911), the transmitting apparatus 917 for transmitting data to the storage apparatus (the IC tag 820), the receiving apparatus 918 for receiving data from the storage apparatus (the IC tag 820), the common command acquiring unit 161, the identification acquirement instructing unit 171, the identification receiving unit 181, the command group deciding unit (the protocol deciding unit 130), the extension command transforming unit 140, an extension command transmitting unit (the command transmitting unit 172), the response receiving unit 182, the response transforming unit 150, and the response notifying unit 162.

The common command acquiring unit 161, by using the processing apparatus (the CPU 911), acquires the common command indicating the instruction from the control apparatus (the PC 810).

The identification acquirement instructing unit 171, by using the transmitting apparatus 917, transmits to the storage apparatus (the IC tag 820) an identification acquiring command that instructs to transmit the identification information (the TID) of the storage apparatus.

The identification receiving unit 181, by using the receiving apparatus 918, receives the identification information (the TID) transmitted by the storage apparatus (the IC tag 820), as a response to the identification acquiring command transmitted by the identification acquirement instructing unit 171.

The command group deciding unit (the protocol deciding unit 130), by using the processing apparatus (the CPU 911), decides the group of the extension commands (the protocol) that the storage apparatus (the IC tag 820) interprets, from the plurality of groups of the extension commands (the protocols), based on the identification information (the TID) received by the identification receiving unit 181.

The extension command transforming unit 140, by using the processing apparatus (the CPU 911), transforms the common command acquired by the common command acquiring unit 161, into the extension command that the storage apparatus (the IC tag 820) interprets, based on the group of the extension commands (the protocol) decided by the command group deciding unit (the protocol deciding unit 130).

The extension command transmitting unit (the command transmitting unit 172), by using the transmitting apparatus 917, transmits the extension command transformed by the extension command transforming unit 140, to the storage apparatus (the IC tag 820).

The response receiving unit 182, by using the receiving apparatus 918, receives the response data transmitted by the storage apparatus (the IC tag 820), as a response to the extension command transmitted by the extension command transmitting unit (the command transmitting unit 172).

The response transforming unit 150, by using the processing apparatus (the CPU 911), transforms the data format of the response data received by the response receiving unit 182 into a prescribed format, to generate the transformed data.

The response notifying unit 162, by using the processing apparatus (the CPU 911), notifies the control apparatus (the PC 810) of the transformed data generated by the response transforming unit 150, as a response to the common command acquired by the common command acquiring unit 161.

According to the data operation apparatus (the RFID reader/writer apparatus 100) of the present embodiment, even if the storage apparatuses (the IC tags 820) that interpret different extension commands (the protocols) are mixedly present, without having to be aware of this fact, the control apparatus (the PC 810) can operate the data stored by the storage apparatuses that interpret different extension commands, by using the same common command.

The data operation apparatus (the RFID reader/writer apparatus 100) of the present embodiment further includes a command deciding unit 110 and the basic command transforming unit 115.

The command deciding unit 110, by using the processing apparatus (the CPU 911), decides whether or not the common command acquired by the common command acquiring unit 161 is a command transformable to the basic command that the storage apparatus interprets, regardless of the type of the storage apparatus (the IC tag 820).

The basic command transforming unit 115, by using the processing apparatus (the CPU 911), transforms the common command acquired by the common command acquiring unit 161 to the basic command, when the command deciding unit 110 decides that the common command acquired by the common command acquiring unit 161 is a command transformable to the basic command.

The extension command transmitting unit (the command transmitting unit 172), by using the transmitting apparatus 917, transmits the basic command transformed by the basic command transforming unit 115 to the storage apparatus (the IC tag 820), when the command deciding unit 110 decides that the common command acquired by the common command acquiring unit 161 is a command transformable to the basic command. When the command deciding unit 110 decides that the common command acquired by the common command acquiring unit 161 is not a command transformable to the basic command, the extension command transmitting unit, by using the transmitting apparatus 917, transmits the extension command transformed by the extension command transforming unit 140 to the storage apparatus (the IC tag 820).

According to the data operation apparatus (the RFID reader/writer apparatus 100) of the present embodiment, in the case that a group of commands that the storage apparatus (the IC tag 820) interprets includes the basic command, defined as standard and interpreted by all storage apparatuses regardless of their types, and the commands uniquely extended by the manufacturers of the storage apparatuses, the basic command transforming unit 115 transforms the common command to the basic command regardless of the types of the storage apparatus (the IC tag 820) when using a function implemented by the basic command. Therefore, there is no need to modify the existing applications.

The data operation apparatus (the RFID reader/writer apparatus 100) of the present embodiment further includes an inner storage apparatus (the flash memory 920) for storing data, and the protocol storing unit 120.

The protocol storing unit 120, by using the inner storage apparatus, stores a block size 524 indicating a number of data included in a single operation block serving as a unit for operating altogether a plurality of data stored by the storage apparatus (the IC tag 820), for each group of the extension commands (the protocol) that the command group deciding unit (the protocol deciding unit 130) decides.

The extension command transforming unit 140, by using the processing apparatus (the CPU 911), decides whether or not the common command acquired by the common command acquiring unit 161 is a common block operation command (the block read command/the block write command) that instructs to operate altogether a plurality of data stored by the storing apparatus (the IC tag 820). When deciding that the common command is the common block operation command, the extension command transforming unit 140 transforms the common command to the extension command, based on the block size 524 stored by the protocol storing unit 120 for the group of the extension commands (the protocol) decided by the command group deciding unit (protocol deciding unit 130).

According to the data operation apparatus (the RFID reader/writer apparatus 100) of the present embodiment, even if block sizes, the unit for operating altogether a plurality of data, are different depending on the types of the storage apparatuses (the IC tag 820), the control apparatus (the PC 810) side can operate altogether a plurality of data stored by the storage apparatuses interpreting different extension commands, without having to be aware of the block size, by using the same common block operation command.

According to the data operation apparatus (the RFID reader/writer apparatus 100) of the present embodiment, the extension command transforming unit 140, by using the processing apparatus (the CPU 911), transforms a single common command acquired by the common command acquiring unit 161 into one or more extension commands.

The response transforming unit 150, by using the processing apparatus (the CPU 911), generates a single transformed data, based on the response data received by the response receiving unit 182, for each one of extension commands transformed from the single common command by the extension command transforming unit 140.

According to the data operation apparatus (the RFID reader/writer apparatus 100) of the present embodiment, even if the extension command transforming unit 140 has transformed the single common command acquired from the control apparatus (the PC 810) into the plurality of extension commands, the response transforming unit 150 generates the single transformed data, based on the response data transmitted to each one of the plurality of extension commands by the storage apparatus (the IC tag 820). When seen from the control apparatus (the PC 810) side, the storage apparatus (the IC tag 820) seems to make a single response to the single common command. Even if the storage apparatuses (the IC tags 820) that interpret different extension commands (protocols) are mixedly present, without having to be aware of this fact, the control apparatus (the PC 810) side can operate the data stored by the storage apparatuses that interpret different extension commands, by using the same common command.

The data operation system (the IC tag readout system 800) of the present embodiment includes a plurality of storage apparatuses (the IC tags 820) and the data operation apparatus (the RFID reader/writer apparatus 100).

Each of the plurality of storage apparatuses (the IC tags 820), interprets any one group of the extension commands among the plurality of groups of the extension commands (the protocols).

According to the data operation system (the IC tag readout system 800) of the present embodiment, even if the storage apparatuses (the IC tags 820) that interpret different extension commands (the protocols) are mixedly present, without having to be aware of this fact, the control apparatus (the PC 810) side can operate the data stored by the storage apparatuses that interpret different extension commands, by using the same common command.

The data operation apparatus (the RFID reader/writer apparatus 100) of the present embodiment can be implemented by using a computer program, which makes a computer having the processing apparatus (the CPU 911) that processes data to function as the data operation apparatus by performing the program.

According to the computer program of the present embodiment, even if the storage apparatuses that interpret different extension commands (the protocols) are mixedly present, without being aware of this fact, the data operation apparatus (the RFID reader/writer apparatus 100) can be implemented that makes the control apparatus (the PC 810) possible to operate the data stored by the storage apparatuses that interpret the different extension commands, by using the same common command.

A data operation method of the data operation apparatus (the RFID reader/writer apparatus 100) for communicating to the storage apparatus (the IC tag 820) according to the instruction from the control apparatus (the PC 810), and for operating the data stored by the storage apparatus, includes the following steps.

The processing apparatus (the CPU 911) acquires the common command indicating the instruction from the control apparatus (the PC 810).

The transmitting apparatus 917 transmits to the storage apparatus (the IC tag 820), the identification acquiring command that instructs to transmit the identification information (the TID) of the storage apparatus.

The receiving apparatus 918 receives the identification information (TID) transmitted by the storage apparatus (the IC tag 820), as a response to the identification acquiring command transmitted by the transmitting apparatus 917.

The processing apparatus (the CPU 911) decides the group of the extension commands (the protocol) that the storage apparatus (the IC tag 820) interprets, among the plurality of groups of the extension commands (the protocols), based on the identification information (the TID) received by the receiving apparatus 918.

The processing apparatus (the CPU 911) transforms the acquired common command into the extension command that the storage apparatus (the IC tag 820) interprets, based on the decided group of the extension commands (the protocol).

The transmitting apparatus 917 transmits the extension command transformed by the processing apparatus (the CPU 911), to the storage apparatus (the IC tag 820).

The receiving apparatus 918 receives the response data transmitted by the storage apparatus (the IC tag 820), as a response to the extension command transmitted by the transmitting apparatus 917.

The processing apparatus (the CPU 911) transforms a data format of the response data received by the receiving apparatus 918 into a prescribed format, to generate the transformed data.

The processing apparatus (the CPU 911) notifies the control apparatus (the PC 810) of the transformed data generated, as the response to the acquired common command.

According to the data operation method of the present embodiment, even if the storage apparatuses (the IC tags 820) that interpret different extension commands are mixedly present, without having to be aware of this fact, the control apparatus (the PC 810) side can operate the data stored by the storage apparatuses that interpret different extension commands, by using the same common command.

The RFID reader/writer apparatus 100 described above includes the antenna 919, a user command transmission and reception controlling unit (the communication apparatus 915), a user command acquiring unit (the common command acquiring unit 161), an extension air command deciding unit (the command deciding unit 110), a TID acquirement instructing unit (the identification acquirement instructing unit 171), an air command transmission and reception controlling unit (the transmitting apparatus 917 and the receiving apparatus 918), a TID acquiring unit (the identification receiving unit 181), a protocol selecting unit (the protocol deciding unit 130), an air command forming unit (the extension command transforming unit 140), a protocol table (the protocol storing unit 120), a tag response acquiring unit (the response receiving unit 182), and a response forming unit (the response transforming unit 150).

An outline of the operation of the IC tag readout system 800 described above is as follows.

A user command (the common command) used in the application operating in the PC 810 is received by a reader (the RFID reader/writer apparatus 100). The reader classifies the user command whether the user command is for executing a standard air command (the basic command), or for executing an extension air command (the extension command).

If the user command is for executing the extension air command, at first, the reader acquires the TID (the identification information), that is an information that a tag (the IC tag 820) of the C1G2 stores as standard, by using the standard air command. The TID is the information comprised of a tag manufacturer's ID, a model ID, and the like.

The reader, based on the acquired TID, selects the air command (the extension command) suitable for the tag. The reader implements a function that the user wishes to implement, by transmitting this air command to the tag.

The reader extracts information from a response signal (the tag response) (the response data) to the transmitted air command from the tag, and forms it, to generate a response to the transmitted user command (the user command response), and sends it back to the PC 810.

The PC 810 and the reader (the RFID reader/writer apparatus 100) are connected by a network cable or the like. The reader (the RFID reader/writer apparatus 100) and the tag (the IC tag 820) communicate wirelessly with each other.

The application operating in the PC 810 executes the user command (the common command), which function is implemented by executing the extension air command. An example of it is “BlockLock” for protecting a specific block in the user memory.

When the user command is executed in the PC 810, the PC 810 transmits the user command to the reader (the RFID reader/writer apparatus 100) via the network cable or the like.

The reader receives the user command at the user command transmission and reception controlling unit (the communication apparatus 915).

The user command acquiring unit (the common command acquiring unit 161) acquires the user command from the user command transmission and reception controlling unit, and stores it. The user command acquiring unit transmits the user command to the extension air command deciding unit (the command deciding unit 110).

The extension air command deciding unit (the command deciding unit 110) decides whether or not the user command (the common command) instructs to execute the extension air command (the extension command). If the user command instructs to execute the extension air command, the extension air command deciding unit notifies the TID acquirement instructing unit (the identification acquirement instructing unit 171). If the user command does not instruct to execute the extension air command, it is the user command for executing the standard air command (the basic command). Therefore, the command transmitting unit 172 communicates to the tag (the IC tag 820), and the response notifying unit 162 responds to the application the user command response (the response data) received by the response receiving unit 182.

If the TID acquirement instructing unit (the identification acquirement instructing unit 171) is notified by the extension air command deciding unit (the command deciding unit 110) that the user command is a command for executing the extension air command, then the TID acquirement instructing unit sends to the air command transmission and reception controlling unit (the transmitting apparatus 917) an instruction to acquire the TID from the tag (the IC tag 820).

The air command transmission and reception controlling unit (the transmitting apparatus 917) transmits the standard air command to the tag, to read an area where the TID of the tag is stored. The TID read by the tag is received by the air command transmission and reception controlling unit (the receiving apparatus 918).

The TID acquiring unit (the identification receiving unit 181) acquires the TID from the air command transmission and reception controlling unit (the receiving apparatus 918), and stores it.

The protocol selecting unit (the protocol deciding unit 130) inputs the user command from the user command acquiring unit (the common command acquiring unit 161), and inputs the TID from the TID acquiring unit (the identification receiving unit 181). Based on these, the protocol selecting unit selects the air command (the extension command) from the protocoltable 520. For example, provided that the user command is B1 and the TID is TID_{B}, the protocol selecting unit sets B1 as an air command, 256 bytes as the memory block size of the tag, and “12” as a memory block amount of the tag.

The air command forming unit (the extension command transforming unit 140) inputs the air command inputted, a memory block size of the tag and a memory block amount of the tag from the protocol selecting unit (the protocol deciding unit 130), and inputs a parameter used by the air command inputted from the user command acquiring unit. The air command forming unit forms the air command, and transmits it to the air command transmission and reception controlling unit (the transmitting apparatus 917).

The air command transmission and reception controlling unit (the transmitting apparatus 917) transmits the transmitted air command (the extension command) to the tag (the IC tag 820).

When the tag (the IC tag 820) receives the air command (the extension command) transmitted from the reader (the RFID reader/writer apparatus 100), the tag (the IC tag 820) executes a process specified in the air command, and responds a tag response (the response data).

The air command transmission and reception controlling unit (the receiving apparatus 918) receives the tag response.

The tag response acquiring unit (the response receiving unit 182) acquires the tag response (the response data) from the air command transmission and reception controlling unit (the receiving apparatus 918) and stores it.

The response forming unit (the response transforming unit 150) receives notification of what is the air command (the extension command) selected from the protocol selecting unit (the protocol deciding unit 130). Based on this, the response forming unit cuts the information necessary for the user command response out of the tag response. The response forming unit changes a field order, adjusts a number of bits, and the like altogether, to generate a user command response data.

The response forming unit (the response transforming unit 150) transmits the generated user command response data (the transformed data) to the user command transmission and reception controlling unit (the communication apparatus 915).

The user command transmission and reception controlling unit (the communication apparatus 915) transmits the data transmitted from the response forming unit (the response transforming unit 150), to the PC 810, as the user command response.

This makes it possible that, even if the air command having the similar or the same function is not identical depending on the types of the tag (the IC tag 820), communication with the tag is performed, without the user's awareness of the types of tags. In this way, several types of the tags can be mixedly present in a system, and a system configuration becomes easy.

In the RFID reader/writer apparatus 100 described above, the protocol storing unit 120 provides the protocol table 520 on a non-volatile storage apparatus (the flash memory 920). The protocol deciding unit 130, in case of selecting the air command (the extension command), refers to the protocol table 520 stored on the non-volatile storage apparatus by the protocol storing unit 120.

Meanwhile, the protocol storing unit 120 may be configured to store the protocol table 520, by using a volatile storage apparatus such as the RAM 914. For example, the protocol storing unit 120, at the initiation time, by using the CPU 911, reads the protocol table stored on the non-volatile storage apparatus such as the flash memory 920, and duplicates it to the volatile storage apparatus such as the RAM 914. The protocol deciding unit 130 and the like searches through the protocol table stored on the RAM 914 by the protocol storing unit 120.

In the RFID reader/writer apparatus 100 described above, the protocol table 520 is provided on the non-volatile storage apparatus (such as the flash memory 920), and the protocol storing unit 120 copies the protocol table onto the volatile storage apparatus (such as the RAM 914), at the initiation time or whenever instructed. The protocol deciding unit 130 refers to the protocol table copied on the volatile storage apparatus by the protocol storing unit 120, in case of selecting the air command (the extension command).

Whichever is the configuration, just updating the protocol table 520 is needed to add a tag using the extension air protocols that are already implemented.

In the RFID reader/writer apparatus 100 described above, the user command (the common command) is classified into the standard air command (the basic command) and the extension air command by distinguishing the extension air command (the extension command). Therefore, each of their processing can be performed separately.

Moreover, since the protocol table (the protocol storing unit 120) stores the block size 524, therefore, even if the block size differs depending on types of the tags (the IC tags 820), the control apparatus (the PC 810) side does not need to be aware of the block size, and the RFID reader/writer apparatus 100 can generate a command suitable for the block size of the tag.

Moreover, since the protocol table (the protocol storing unit 120) provides the block amount 525, so that the RFID reader/writer apparatus 100 can handle a wrong space specification.

The TID is possessed by all of the IC tags 820, and it can be read by the standard air command. The TID is unique depending on the tag types. Therefore, this can be used as the identification information. Based on the TID, the protocol deciding unit 130 checks the table to decide which extension air command can be interpreted by the IC tag 820. Accordingly, the ready-made IC tag 820 can be used, without having to acquire information from the IC tag 820 on which type of extension command is being used. So, there is no need to prepare a special function to the IC tag 820. Therefore, the IC tag readout system 800 (the data operation system) can be implemented at a low cost.

Moreover, the extension command transforming unit 140 receives a single user command (the common command), and expands it into a plurality of air commands (the extension commands). The response forming unit (the response transforming unit 150) generates the user command response (the transformed data) by cutting the necessary response only out of the returned responses (the response data). Therefore, the user does not need to be aware of actually how many air commands (the extension commands) are expanded a single user command (the common command) into.

Meanwhile, the protocol storing unit 120 does not need to store all extension commands that the IC tag 820 interprets. It may have a configuration that stores only partially among the group of the extension commands that the IC tag 820 interprets. In this way, for example, if the IC tag 820 should not execute some extension air commands among the extension air commands that the IC tag 820 can interpret, due to its license restriction, the protocol storing unit 120 can readily restrict its communication by deleting from the protocol table the extension commands that should not be executed.

### Second Embodiment

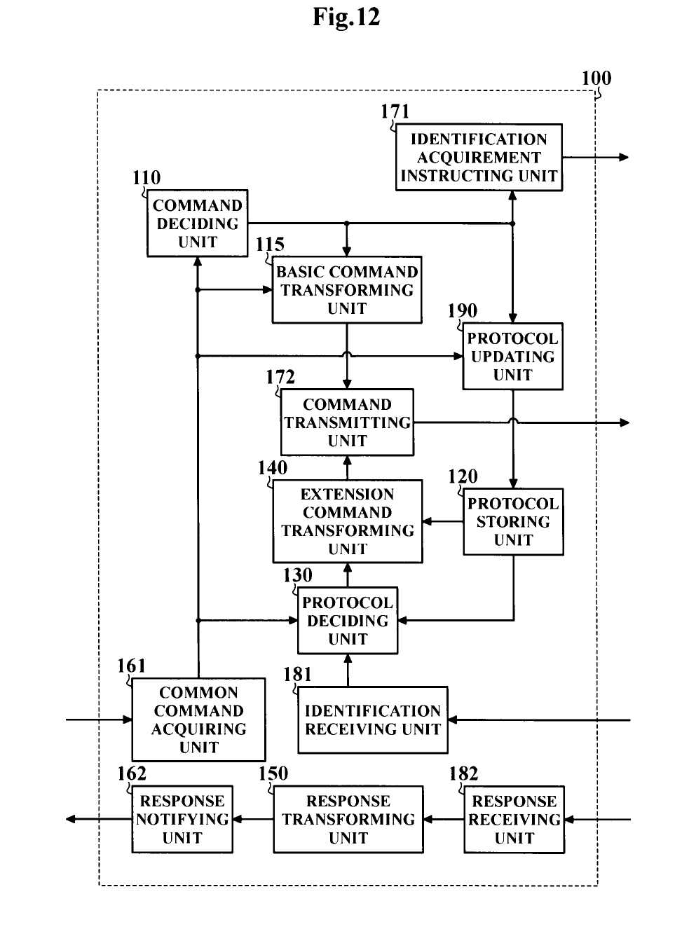

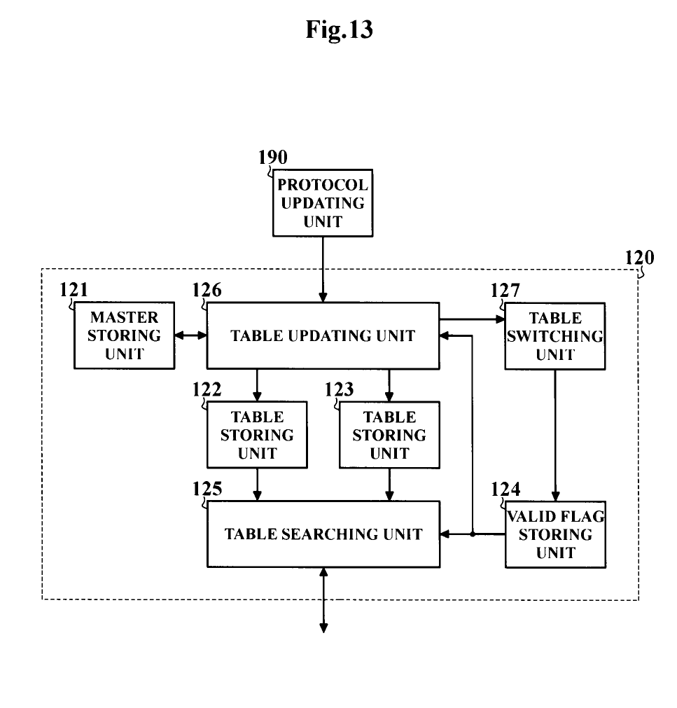

The second embodiment will be described with reference to the drawings of FIGS. 12 and 13.

The explanation is omitted for the portions that are equivalent to the IC tag readout system 800 described in the first embodiment since the identical reference numerals are being used.

FIG. 12 illustrates the block configuration chart as one example of the RFID reader/writer apparatus 100 according to the present embodiment.

The RFID reader/writer apparatus 100 further includes a protocol updating unit 190 in addition to the functional blocks described in the first embodiment.

The RFID reader/writer apparatus 100 of the present embodiment processes a control command, as the common command, indicating an instruction to the RFID reader/writer apparatus 100 itself, beside the command indicating the instruction to the IC tag 820 such as the basic command.

The command deciding unit 110, by using the CPU 911, inputs the common command outputted by the common command acquiring unit 161. The command deciding unit 110, by using the CPU 911, decides whether the inputted common command is the control command, the basic command, or the command corresponding to the extended command. The command deciding unit 110, by using the CPU 911, outputs the decided result.

The protocol updating unit 190, by using the CPU 911, inputs the decided result outputted by the command deciding unit 110. When the command deciding unit 110 decides that the common command acquired by the common command acquiring unit 161 is the control command, the protocol updating unit 190, by using the CPU 911, inputs the common command outputted by the common command acquiring unit 161. The protocol updating unit 190, by using the CPU 911, decides whether or not the inputted common command is a command that instructs to update the protocol table 520 (hereinafter referred to as the “update command”).

When the protocol updating unit 190, by using the CPU 911, decides that the inputted common command is the update command, the protocol updating unit 190 updates the protocol table 520 stored by the protocol storing unit 120.

FIG. 13 illustrates one example of the block configuration chart showing the detailed block configuration of the protocol storing unit 120, in accordance with the present embodiment.

The protocol storing unit 120 includes a master storing unit 121, two table storing units 122 and 123, a valid flag storing unit 124, a table searching unit 125, a table updating unit 126, and a table switching unit 127.

The master storing unit 121 stores a protocol table by using the flash memory 920.

Each of the two table storing units 122 and 123 stores the protocol table by using the RAM 914.

The valid flag storing unit 124 stores a flag (hereinafter referred to as the “valid flag”) that indicates which one of the two table storing units 122 and 123 is valid.

The table searching unit 125, by using the CPU 911, according to a request from the protocol deciding unit 130, searches through a protocol table stored by a valid table storing unit of the two table storing units 122 and 123, and returns the result searched.

The table searching unit 125, by using the CPU 911, inputs the valid flag stored by the valid flag storing unit 124. The table searching unit 125, by using the CPU 911, decides which one of the two table storing units 122 and 123 is valid, based on the inputted valid flag. The table searching unit 125, by using the CPU 911, searches through the protocol table stored by the table storing unit decided valid.

The table updating unit 126, by using the CPU 911, updates the protocol table stored by the master storing unit 121, the table storing units 122 or 123, in accordance with an instruction from the protocol updating unit 190.

The table updating unit 126, by using the CPU 911, inputs the protocol table stored by the master storing unit 121. The table updating unit 126, by using the CPU 911, updates the protocol table stored by the master storing unit 121, in accordance with the instruction from the protocol updating unit 190. The master storing unit 121, by using the flash memory 920, stores the updated protocol table.

The table updating unit 126, by using the CPU 911, inputs the valid flag stored by the valid flag storing unit 124. The table updating unit 126, by using the CPU 911, decides which one of the two table storing units 122 and 123 is valid, based on the inputted valid flag. The table updating unit 126, by using the CPU 911, updates the protocol table stored by the table storing unit 122 or 123 which is decided invalid, to the same contents as the protocol table stored by the master storing unit 121. The table storing unit which is decided invalid, by using the RAM 914, stores the updated protocol table.

When the table updating unit 126 finishes the update of the protocol table, the table switching unit 127, by using the CPU 911, rewrites the valid flag stored by the valid flag storing unit 124, to reverse valid and invalid. That is, when the table storing unit 122 is valid, the table switching unit 127 rewrites the valid flag as indicating that the table storing unit 123 is valid. In reverse, when the table storing unit 123 is valid, the table switching unit 127 rewrites the valid flag as indicating that the table storing unit 123 is valid. The valid flag storing unit 124, by using the RAM 914, stores the rewritten valid flag.

Meanwhile, the configuration may be as below. The table switching unit 127, by using the CPU 911, decides whether the table searching unit 125 is in process of searching through the protocol table or not. When deciding that the table searching unit 125 is in process of searching through the protocol table, the table switching unit 127 waits until the table searching unit 125 finishes the search, then rewrites the valid flag stored by the valid flag storing unit 124.

Moreover, the table updating unit 126, by using the CPU 911, when initiation is required such as immediately after power on, initializes the protocol table stored by the table storing unit 122.

The table updating unit 126, by using the CPU 911, inputs the protocol table stored by the master storing unit 121. The table updating unit 126, by using the CPU 911, initializes the protocol table stored by the table storing unit 122 to the same contents as the inputted protocol table. The table storing unit 122, by using the RAM 914, stores the initialized protocol table.

The table switching unit 127, by using the CPU 911, when the table updating unit 126 finishes the initialization of the protocol table, initializes the valid flag stored by the valid flag storing unit 124 to the valid flag indicating that the table storing unit 122 is valid. The valid flag storing unit 124, by using the RAM 914, stores the initialized valid flag.

During the update of the protocol table, the protocol table stored by the table storing unit which is in a progress of the updating may not be consistent. However, the table searching unit 125 searches through a table storing unit which is different from a table storing unit storing the protocol table which is being updated by the table updating unit 126. Therefore, the table searching unit 125 doesn't access the protocol table that is not consistent.

After finishing the update of the protocol table by the table updating unit 126, the table switching unit 127 rewrites the valid flag stored by the valid flag storing unit 124. Then the table searching unit 125 searches through the updated protocol table.

In this way, even if the IC tag readout system 800 is in process of operation, the protocol table stored by the protocol storing unit 120 can be updated.

For example, in the case that the acceptance of the IC tags 820 of the different manufacturers or the same manufacturer's new versions increases the number of the protocols that the IC tags 820 interpret, there is a need to update the protocol table stored by the protocol storing unit 120. Even if this is the case, there is no need to stop the operation of the IC tag readout system 800, and the PC 810 can update the protocol table by providing the control command that instructs updating of the protocol table to the RFID reader/writer apparatus 100 as the common command.

Further, the valid flag does not need to be rewritten immediately after the end of the updating of the protocol table. The configuration may be as follows: the valid flag is rewritten when the common command acquiring unit 161 acquires a control command that instructs switching of the protocol table as the common command.

Moreover, the two table storing units 122 and 123 may not store the protocol table by using the volatile storage apparatus such as the RAM 914, but they may store the protocol table by using the non-volatile storage apparatus such as the flash memory 920. In this case, the configuration of the protocol storing unit 120 can be constructed without the master storing unit 121.

According to the data operation apparatus (the RFID reader/writer apparatus 100) of the present embodiment, the protocol storing unit 120 includes the plurality of table storing units 122 and 123, the valid flag storing unit 124, the table updating unit 126, and the table switching unit 127.

Each one of the plurality of table storing units 122 and 123, by using the inner storage apparatus (the RAM 914), stores the protocol table 520 including the extension command 523 that the storage apparatus (the IC tag 820) interprets and the block size 524, for each one of the groups of the extension commands (the protocols) that the command group deciding unit (the protocol deciding unit 130) decides.

The valid flag storing unit 124, by using the inner storage apparatus (the RAM 914), stores the valid flag indicating which one is valid among the plurality of table storing units 122 and 123.

The table updating unit 126, by using the processing apparatus (the CPU 911), when the common command acquired by the common command acquiring unit 161 serves as the command that instructs an updating of the protocol table 520 (the table updating command), updates the protocol table 520 stored by the invalid table storing unit, based on the valid flag stored by the valid flag storing unit 124.

The table switching unit 127, by using the processing apparatus (the CPU 911), updates the valid flag stored by the valid flag storing unit 124, to make valid the table storing unit updated by the table updating unit 126.

This leads that, when the protocol table 520 stored by the protocol storing unit 120 need be updated such that the types of the storage apparatus (the IC tag 820) used in the data operation system (the IC tag readout system 800) increases, the protocol table 520 can be updated while operating the data operation system.

The RFID reader/writer apparatus 100 described above includes a user command transmitting and receiving unit (the communication apparatus 915), the user command acquiring unit (the common command acquiring unit 161), a table updating command deciding unit (the protocol updating unit 190), a protocol table A valid flag and a protocol table B valid flag (the valid flag storing unit 124), a generating table selecting unit and a table generating unit (the table updating unit 126), a table flag validation unit (the table switching unit 127), a protocol table A (the table storing unit 122), a protocol table B (the table storing unit 123), and the response forming unit (the response transforming unit 150).

The operation of the IC tag readout system 800 described above is outlined below.

The PC 810 previously stores the protocol table to be updated as a file for updating the table.

The PC 810 executes the table updating command for updating the protocol table.

When the table updating command is executed, the PC 810 transmits the table updating command and a specified file to the reader (the RFID reader/writer apparatus 100), via the network cable or the like.

When deciding that the received command is the table updating command, the reader (the RFID reader/writer apparatus 100) generates a new protocol table from the received file.

The PC 810 stores the protocol table used for updating as a file for updating the table.

The PC 810 executes the table updating command (the update command) as the user command (the common command), for updating the protocol table.

The table updating command has an argument that specifies the file for updating the table.

The PC 810 transmits the table updating command, to the reader (the RFID reader/writer apparatus 100), via the network cable or the like. The PC 810 transmits the file for updating the table together with the table updating command.

The table updating command and the file for updating the table are received by the user command transmission and reception controlling unit (the communication apparatus 915).

The user command acquiring unit (the common command acquiring unit 161) acquires the user command (the common command) from the user command transmission and reception controlling unit (the communication apparatus 915) and stores it. The user command acquiring unit transmits the user command to the table updating command deciding unit (the protocol updating unit 190).

The table updating command deciding unit (the protocol updating unit 190) decides whether or not the user command is the table updating command. When the user command is the table updating command, the table updating command deciding unit notifies the generating table selecting unit (the table updating unit 126), and the updating process of the protocol table starts. When the user command is not the table updating command, a function of the command is executed as usual, and the updating process of the protocol table is not executed.

When the updating process of the protocol table starts, the generating table selecting unit (the table updating unit 126) confirms the states of the protocol table A valid flag and the protocol table B valid flag.

These flags indicate which one of the two protocol tables (the table storing units 122 and 123) is valid.

For example, the case in which the protocol table A is valid and the protocol table A valid flag is set as significant will be described.

The generating table selecting unit (the table updating unit 126) decides that the protocol table B is invalid, and instructs to the table generating unit (the table updating unit 126) to generate a new protocol table onto the protocol table B.

The table generating unit (the table updating unit 126) sequentially reads the file for updating the table stored by the user command transmission and reception controlling unit (the communication apparatus 915), and generates the new protocol table onto the protocol table B. When the generation of the new protocol table finishes, the table generating unit (the table updating unit 126) notifies the table flag validation unit (the table switching unit 127).

The table flag validation unit (the table switching unit 127) makes the old protocol table invalid by setting the protocol table A valid flag insignificant. Then, the table flag validation unit makes the new protocol table valid by setting the protocol table B valid flag significant. The protocol table is updated accordingly.

The table updating command deciding unit (the protocol updating unit 190) notifies the response forming unit (the response transforming unit 150) that the user command is the table updating command. The table flag validation unit (the table switching unit 127) notifies the response forming unit that the updating of the protocol table has finished. When receiving notification of the completion of the updating, the response forming unit incorporates a process ending code if finished normally, and an abnormal ending code if finished abnormally, into the user command response, adjusts it, and transmits it to the user command transmission and reception controlling unit (the communication apparatus 915).

The user command transmission and reception controlling unit (the communication apparatus 915) transmits the user command response to the PC 810 via the network cable or the like.

This leads that, even if the types of tags supported by the IC tag readout system 800 increases, there is no need to remake the hardware or software, and just the protocol table has to be updated, so that an efficiency of the development is improved. Moreover, with an installation of a specialized command, the protocol table can be easily updated from the field.

### Third Embodiment

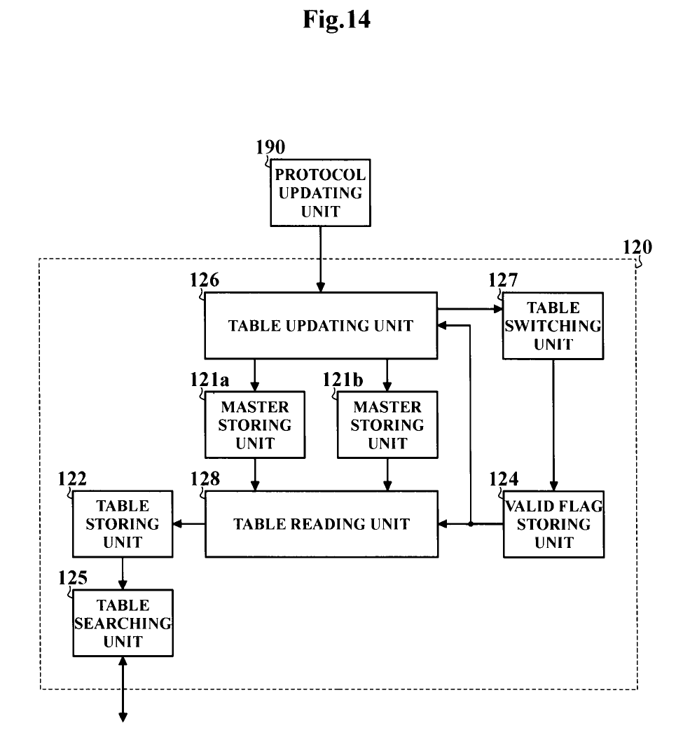

The third embodiment will be described with reference to the drawing of FIG. 14.

The explanation is omitted for the portions that are equivalent to the IC tag read out system 800 described in the second embodiment since the identical reference numerals are being used.

FIG. 14 illustrates the block configuration chart showing one example of the detailed block configuration of the protocol storing unit 120, in accordance with the present embodiment.

The protocol storing unit 120 includes two master storing units 121a and 121b, the table storing unit 122, the valid flag storing unit 124, the table searching unit 125, the table updating unit 126, the table switching unit 127, and a table reading unit 128.

Each of the two master storing units 121a and 121b, by using the flash memory 920, stores the protocol table.

The table storing unit 122, by using the RAM 914, stores the protocol table.

The table searching unit 125, by using the CPU 911, searches through the protocol table stored by the table storing unit 122, according to the request from the protocol deciding unit 130 and the like, and returns the searched result.

The valid flag storing unit 124 (the master valid flag storing unit), by using the flash memory 920, stores a valid flag (the master valid flag) that indicates which one of the two master storing units 121a and 121b is valid.

The table updating unit 126, by using the CPU 911, updates the protocol table stored by the master storing units 121a and 121b, in accordance with an instruction from the protocol updating unit 190.

The table updating unit 126, by using the CPU 911, inputs the valid flag stored by the valid flag storing unit 124. The table updating unit 126, by using the CPU 911, based on the inputted valid flag, decides which one of the two master storing units 121a and 121b is valid. The table updating unit 126, by using the CPU 911, inputs a protocol table stored by the master storing unit decided invalid. The table updating unit 126, by using the CPU 911, updates the inputted protocol table, in accordance with the instruction from the protocol updating unit 190. The master storing unit decided invalid, by using the flash memory 920, stores the updated protocol table.

When the table updating unit 126 finishes the updating of the protocol table. The table switching unit 127, by using the CPU 911 rewrites the valid flag stored by the valid flag storing unit 124 , to reverse valid and invalid. The valid flag storing unit 124, by using the flash memory 920, stores the valid flag which is rewritten.

When the initiation is required such as immediately after switching on the power source, or when the valid flag stored by the valid flag storing unit 124 is rewritten, the table reading unit 128, by using the CPU 911, reads the protocol table stored by the master storing unit into the table storing unit 122.

The table reading unit 128, by using the CPU 911, inputs the valid flag stored by the valid flag storing unit 124. The table reading unit 128, by using the CPU 911, based on the inputted valid flag, decides which one of the two master storing units 121a and 121b is valid. The table reading unit 128, by using the CPU 911, inputs the protocol table stored by the master storing unit decided valid. The table reading unit 128, by using the CPU 911, rewrites the protocol table stored by the table storing unit 122, to the same contents as the inputted protocol table. The table storing unit 122, by using the RAM 914, stores the protocol table rewritten.

Equipping two master storing units like this effects as below: even if abnormal termination of the RFID reader/writer apparatus 100 during the update of the protocol table results in an incomplete updating of the protocol table, and the protocol table stored by the master storing unit which was in process of updating is not consistent, the valid one of the master storing unit stores the protocol table before the updating. Therefore, after a recovery, the table reading unit 128 reads the protocol table before updating into the table storing unit 122, and the RFID reader/writer apparatus 100 can operate normally.

Just like the second embodiment, the configuration may have two table storing units. For example, the table searching unit 125 searches through the protocol table stored by the valid one out of the two table storing units. The table reading unit 128 reads the protocol table to the invalid one out of the two table storing units, and switches the valid table storing unit.

The data operation apparatus (the RFID reader/writer apparatus 100) of the present embodiment further includes a non-volatile inner storage apparatus (the flash memory 920) that is non-volatile and stores the data.

The protocol storing unit 120 includes a plurality of master storing units 121a and 121b, a master valid flag storing unit (the valid flag storing unit 124), the table updating unit 126, the table switching unit 127, and a table storing unit 122.

Each one of the plurality of master storing units 121a and 121b, by using the non-volatile inner storage apparatus (the flash memory 920), stores the protocol table 520 which includes the extension command 523 that the storage apparatus (the IC tag 820) interprets and the block size 524, for each group of the extension commands (the protocols) that the command group deciding unit (the protocol deciding unit 130) decides.

The master valid flag storing unit (the valid flag storing unit 124), by using the inner storage apparatus (the RAM 914), stores the master valid flag (the valid flag) that indicates which one of the plurality of the master storing units 121a and 121b is valid.

The table updating unit 126, by using the processing apparatus (the CPU 911), when the common command acquired by the common command acquiring unit 161 is the command that instructs to update the protocol table (the table updating command), based on the master valid flag (the valid flag) stored by the master valid flag storing unit (the valid flag storing unit 124), updates the protocol table 520 stored by the invalid one of the master storing units.

The table switching unit 127, by using the processing apparatus (the CPU 911), updates the master valid flag (the valid flag) stored by the master valid flag storing unit, and makes the master storing unit updated by the table updating unit 126 valid.

The table storing unit 122, by using the inner storage apparatus (the RAM 914), based on the master valid flag (the valid flag) stored by the master valid flag storing unit (the valid flag storing unit 124), reads and stores the protocol table 520 stored by the valid one of the master storing units.

This leads as below: even in the case that the protocol table 520 stored by the protocol storing unit 120 needs to be updated, such as the types of storage apparatus (the IC tag 820) used in the data operation system (the IC tag readout system 800) increases, the protocol table 520 can be updated while the data operation system keeps on operating.

According to the RFID reader/writer apparatus 100 described above includes the user command transmitting and receiving unit (the communication apparatus 915), the user command acquiring unit (the common command acquiring unit 161), the table updating command deciding unit (the protocol updating unit 190), a protocol table A master valid flag and a protocol table B master valid flag (the valid flag storing unit 124), a generating table master selecting unit and a table master generating unit (the table updating unit 126), a table master flag validation unit (the table switching unit 127), a protocol table A master (the master storing unit 121a), a protocol table B master (the master storing unit 121b), a protocol table loading unit (the table reading unit 128), the protocol table (the table storing unit 122), and the response forming unit (the response transforming unit 150).

The operation of the IC tag readout system 800 described above is outlined as follows.

A master file of the protocol table is placed on the non-volatile storage apparatus (the flash memory 920 or a magnetic disk apparatus), which is copied to the non-volatile storage apparatus (the RAM 914) at the initiation time or when being instructed (for example, the protocol table is handled as a program variable, and copied to a variable area on DPAM) When selecting the air command, the protocol table copied to the volatile storage apparatus is referred.

When the updating process of the protocol table starts, the generating table master selecting unit (the table updating unit 126) confirms the states of the protocol table A master valid flag and the protocol table B master valid flag.

These flags indicate which one of the two protocol table masters (the master storing unit 121a and 121b) is valid.

For example, the case is described in which the protocol table A master is valid, and the protocol table A master valid flag is significant.

The generating table master selecting unit (the table updating unit 126) decides that the protocol table B master is invalid, and instructs the table master generating unit (the table updating unit 126) to generate the new protocol table master onto the protocol table B master.

The table master generating unit (the table updating unit 126) sequentially reads the file for updating the table stored by the user command transmission and reception controlling unit (the common command acquiring unit 161), and generates the new protocol table master onto the protocol table B master. When the generation of the new protocol table master completes, the table master generating unit (the table updating unit 126) notifies the table master flag validation unit (the table switching unit 127).

The table master flag validation unit (the table switching unit 127) sets the protocol table A master valid flag as insignificant, and makes the old protocol table master invalid. Then the table master flag validation unit sets the protocol table B master valid flag as significant, and makes the new protocol table master valid. The protocol table master is updated accordingly.

After setting the protocol table B master valid flag as significant, the table master flag validation unit (the table switching unit 127) notifies the protocol table loading unit (the table reading unit 128). The protocol table loading unit refers to the protocol table A master valid flag and the protocol table B master valid flag, decides that the protocol table B master as valid, reads the protocol table B master, and updates the protocol table.

Accordingly, even if the number of tag types that support the IC tag readout system 800 increases, there is no need to reconstruct the hardware and software. The development efficiency is improved because just updating the protocol table is needed. Moreover, with the installation of the specialized command, the protocol table is readily updated from the field.

### Fourth Embodiment

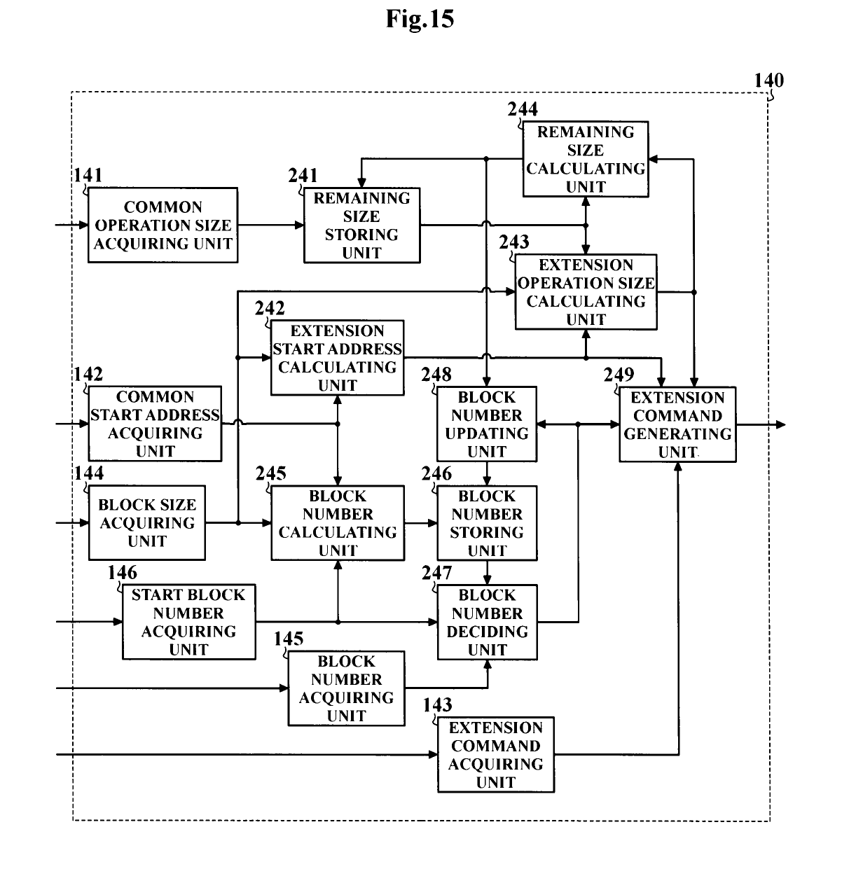

The fourth embodiment will be described with reference to the drawings of FIGS. 15 to 17.

The explanation is omitted for the portions that are equivalent to the IC tag readout system 800 described in the first to third embodiments since the identical reference numerals are being used.

The present embodiment describes the case that the IC tag 820 interprets not only the extension command that reads and writes a memory block overall, but also the extension command that reads and writes a portion of the memory block (hereinafter referred to as the “extension block operation command”).

Moreover, corresponding to this, a slight modification is added to the specification of the common commands. The common command that reads and writes by specifying a voluntary area of the memory area of the IC tag 820 (hereinafter referred to as the “common block operation command”) is added.

In the common block operation command, reading and writing of the data is performed by specifying the memory area subjected to the operation. There are various methods available as methods for specifying the memory area subjected to the operation in the case described herein as an example, it specifies a start address of the memory area subjected to the operation (hereinafter referred to as the “common start address”) and a size of the memory area subjected to the operation (hereinafter referred to as the “common operation size”).

Specification of the extension block operation command differs for each protocol that the IC tag 820 interprets. However, in respect to reading or writing of the data by specifying of the memory area subjected to the operation, it is the same as the common block operation command. In the specifying method of the memory area subjected to the operation described herein as an example, it specifies a block number of the block including the memory area subjected to the operation, a start address of the memory area subjected to the operation within that block (hereinafter referred to as the “extension start address”) and a size of the memory area subjected to the operation (hereinafter referred to as the “extension operation size”).

FIG. 15 illustrates the block configuration chart showing one example of the detailed block configuration of the extension command transforming unit 140, in accordance with the present embodiment.

Meanwhile, in this drawing, only the portions of relevance to the case in which the common command outputted by the protocol deciding unit 130 serving as the common block operation command is shown.

The extension command transforming unit 140 includes a common operation size acquiring unit 141, a common start address acquiring unit 142, an extension command acquiring unit 143, a block size acquiring unit 144, a block amount acquiring unit 145, a start block number acquiring unit 146, a remaining size storing unit 241, an extension start address calculating unit 242, an extension operation size calculating unit 243, a remaining size calculating unit 244, a block number calculating unit 245, a block number storing unit 246, a block number deciding unit 247, a block number updating unit 248, and an extension command generating unit 249.

The common operation size acquiring unit 141, by using the CPU 911, acquires the common operation size specified in the common block operation command outputted by the protocol deciding unit 130. The common operation size acquiring unit 141, by using the CPU 911, outputs the acquired common operation size.

The common start address acquiring unit 142, by using the CPU 911, acquires the common start address specified in the common block operation command outputted by the protocol deciding unit 130. The common start address acquiring unit 142, by using the CPU 911, outputs the acquired common start address.

The extension command acquiring unit 143, by using the CPU 911, inputs the extension command 523 outputted by the protocol deciding unit 130. The extension command acquiring unit 143, by using the CPU 911, outputs the inputted extension command 523.

The block size acquiring unit 144, by using the CPU 911, inputs the block size 524 outputted by the protocol deciding unit 130. The block size acquiring unit 144, by using the CPU 911, outputs the inputted block size 524.

The block amount acquiring unit 145, by using the CPU 911, inputs the block amount 525 outputted by the protocol deciding unit 130. The block amount acquiring unit 145, by using the CPU 911, outputs the inputted block amount 525.

The start block number acquiring unit 146, by using the CPU 911, inputs the start block number 526 outputted by the protocol deciding unit 130. The start block number acquiring unit 146, by using the CPU 911, outputs the inputted start block number.

The remaining size storing unit 241, by using the CPU 911, inputs the common operation size outputted by the common operation size acquiring unit 141. The remaining size storing unit 241, by using the RAM 914, stores the common operation size inputted, as a remaining size.

Moreover, the remaining size storing unit 241, by using the CPU 911, inputs the remaining size outputted by the remaining size calculating unit 244, which will be described later. When inputting the remaining size, the remaining size storing unit 241, by using the RAM 914, stores the inputted remaining size by overwriting.

The extension start address calculating unit 242, by using the CPU 911, inputs the common start address outputted by the common start address acquiring unit 142, and the block size outputted by the block size acquiring unit 144. The extension start address calculating unit 242, by using the CPU 911, based on the inputted start address and the block size, calculates the extension start address of the first extension block operation command for the single common block operation command. The extension start address calculating unit 242, by using the CPU 911, outputs the calculated extension start address.

For example, the extension start address calculating unit 242 calculates a remainder obtained from dividing the inputted common start address by the inputted block size, to get the extension start address.

The extension operation size calculating unit 243, by using the CPU 911, inputs the block size outputted by the block size acquiring unit 144, the remaining size stored by the remaining size storing unit 241, and the extension start address outputted by the extension start address calculating unit 242. The extension operation size calculating unit 243 calculates the extension operation size of the extension block operation command, based on the inputted block size, the remaining size, and the extension start address. The extension operation size calculating unit 243, by using the CPU 911, outputs the calculated extension operation size.

For example, the extension operation size calculating unit 243, by using the CPU 911, decides if the calculated extension operation size belongs to the first extension block operation command for the single common block operation command, or belongs to the second extension block operation command or later. When deciding that it belongs to the first extension block operation command, the extension operation size calculating unit 243 calculates the remaining size of the first block (hereinafter referred to as the “block remaining size”) by deducting the inputted block size from the inputted extension start address. When deciding that it belongs to the second extension block operation command or later, the extension operation size calculating unit 243, by using the CPU 911, sets the inputted block size as the block remaining size of the second block or later. The extension operation size calculating unit 243, by using the CPU 911, compares the calculated block remaining size with the inputted remaining size, and sets the smaller one as the extension operation size.

The remaining size calculating unit 244, by using the CPU 911, inputs the remaining size stored by the remaining size storing unit 241, and the extension operation size outputted by the extension operation size calculating unit 243. The remaining size calculating unit 244, by using the CPU 911, deducts the inputted extension operation size from the inputted remaining size, to calculate a new remaining size. The remaining size calculating unit 244, by using the CPU 911, outputs the calculated remaining size.

The block number calculating unit 245, by using the CPU 911, inputs the common start address outputted by the common start address acquiring unit 142, the block size outputted by the block size acquiring unit 144, and the start block number outputted by the start block number acquiring unit 146. The block number calculating unit 245, by using the CPU 911, calculates the block number of the first extension block operation command, based on the inputted common start address, the block size, and the start block number. The block number calculating unit 245, by using the CPU 911, outputs the calculated block number.

For example, the block number calculating unit 245, by using the CPU 911, calculates a quotient obtained from dividing the inputted common start address by the inputted block size (the remainder is rounded off), and calculates a sum of the calculated quotient and the inputted start block number, to get the block number.

The block number storing unit 246, by using the CPU 911, inputs the block number outputted by the block number calculating unit 245. The block number storing unit 246, by using the RAM 914, stores the inputted block number.

Moreover, the block number storing unit 246, by using the CPU 911, inputs the block number outputted by the block number updating unit 248 which will be described later. When inputting the block number outputted by the block number updating unit 248, the block number storing unit 246, by using the RAM 914, stores the inputted block number by overwriting.

The block number deciding unit 247, by using the CPU 911, inputs the block number stored by the block number storing unit 246, the block amount outputted by the block amount acquiring unit 145, and the start block number outputted by the start block number acquiring unit 146. The block number deciding unit 247, by using the CPU 911, based on the inputted block amount and the start block number, decides whether or not a block having the inputted block number exists in the IC tag 820. The block number deciding unit 247, by using the CPU 911, outputs the inputted block number When deciding that the block of the inputted block number exists in the IC tag 820.

For example, the block number deciding unit 247, by using the CPU 911, calculates a sum of the inputted block amount and the inputted start block number, and compares the calculated sum with the inputted block number. The block number deciding unit 247, by using the CPU 911, when the calculated sum is greater than the block number, decides that the block having the inputted block number exists in the IC tag 820, and when the calculated sum is less than or equal to the inputted block number, decides that the block having the inputted block number does not exist in the IC tag 820.

The block number updating unit 248, by using the CPU 911, inputs the block number outputted by the block number deciding unit 247 and the remaining size outputted by the remaining size calculating unit 244. The block number updating unit 248, by using the CPU 911, decides whether or not the inputted remaining size is 0. When deciding that the inputted remaining size is not 0, the block number updating unit 248, by using the CPU 911, adds 1 to the inputted block number, to get the new block number. The block number updating unit 248, by using the CPU 911, outputs the calculated block number.

The extension command generating unit 249, by using the CPU 911, inputs the extension command outputted by the extension command acquiring unit 143, the block number outputted by the block number deciding unit 247, the extension start address outputted by the extension start address calculating unit 242, and the extension operation size outputted by the extension operation size calculating unit 243. The extension command generating unit 249, by using the CPU 911, based on the inputted extension command, the block number, the extension start address, and the extension operation size, generates the extension block operation command with specifications of the block number, the extension start address, and the extension operation size. The extension command generating unit 249, by using the CPU 911, outputs the generated extension block operation command.

For example, the extension command generating unit 249, by using the CPU 911, decides whether the extension block operation command to be generated is the first extension block operation command for the single common block operation, or the second extension block operation command or later. When deciding that the extension block operation command to be generated is the first extension block operation command, the extension command generating unit 249 specifies the inputted block number as the block number, the inputted extension start address as the extension start address, and the inputted extension operation size as the extension operation size, then generates the extension block operation command. When deciding that the extension block operation command to be generated is the second extension block operation command or later, the extension command generating unit 249, by using the CPU 911, specifies the inputted block number as the block number, “0” as the extension start address, and the inputted extension operation size as the extension operation size, then generates the extension block operation command.

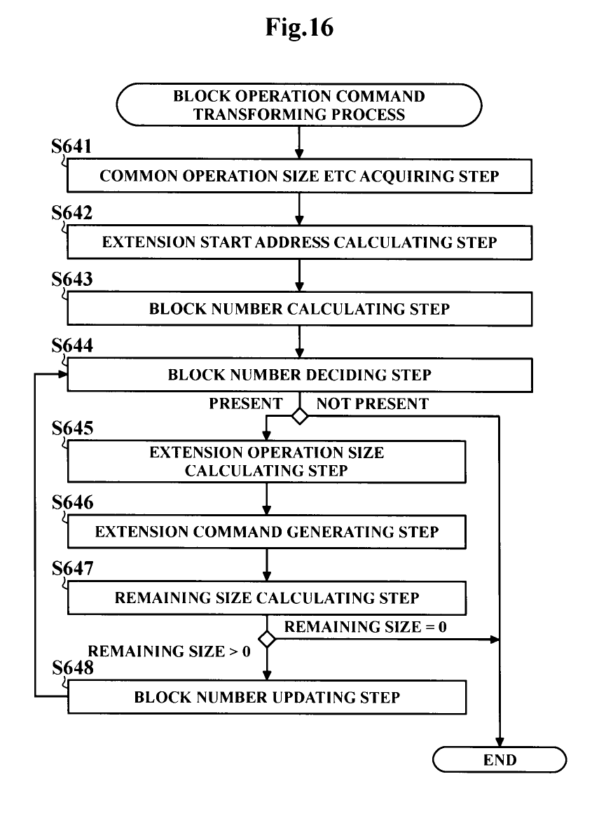

FIG. 16 illustrates the flow chart showing one example of the flow of the block operation command transforming process in which the extension command transforming unit 140 of the present embodiment transforms the block operation command.

The extension command transforming unit 140, by using the CPU 911, decides a type of the common command outputted by the protocol deciding unit 130. The extension command transforming unit 140, by using the CPU 911, based on the types of the common command decided, executes the command transforming process that corresponds to the type of the common commands. The block operation command transforming process is executed when the common command outputted by the protocol deciding unit 130 serves as the common block operation command.

The block operation command transforming process, for example, includes a common operation size etc acquiring step S641, an extension start address calculating step S642, a block number calculating step S643, a block number deciding step S644, an extension operation size calculating step S645, an extension command generating step S646, a remaining size calculating step S647, and a block number updating step S648.

In the common operation size etc acquiring step S641, the common operation size acquiring unit 141, by using the CPU 911, acquires the common operation size specified in the common block operation command outputted by the protocol deciding unit 130. The common start address acquiring unit 142, by using the CPU 911, acquires the common start address specified in the common block operation command outputted by the protocol deciding unit 130. The extension command acquiring unit 143, by using the CPU 911, inputs the extension command 523 outputted by the protocol deciding unit 130. The block size acquiring unit 144, by using the CPU 911, inputs the block size 524 outputted by the protocol deciding unit 130. The block amount acquiring unit 145, by using the CPU 911, inputs the block amount 525 outputted by the protocol deciding unit 130. The start block number acquiring unit 146, by using the CPU 911, inputs the start block number 526 outputted by the protocol deciding unit 130. The remaining size storing unit 241, by using the RAM 914, stores the common operation size acquired by the common operation size acquiring unit 141.

In the extension start address calculating step S642, the extension start address calculating unit 242, by using the CPU 911, calculates the extension start address of the first block, based on the common start address acquired by the common start address acquiring unit 142 and the block size inputted by the block size acquiring unit 144 in the common operation size etc acquiring step S641.

In the block number calculating step S643, the block number calculating unit 245, by using the CPU 911, calculates the block number of the first block, based on the common start address acquired by the common start address acquiring unit 142, a block size inputted by the block size acquiring unit 144, and a start block number inputted by the start block number acquiring unit 146 in the common operation size etc acquiring step S641. The block number storing unit 246, by using the RAM 914, stores the block number calculated by the block number calculating unit 245.

In the block number deciding step S644, the block number deciding unit 247, by using the CPU 911, decides whether or not a block having the block number stored by the block number storing unit 246 exists in the IC tag 820, based on the block amount inputted by the block amount acquiring unit 145 and the start block number inputted by the start block number acquiring unit 146 in the common operation size etc acquiring step S641.

When the block number deciding unit 247 decides that the block having the block number stored by the block number storing unit 246 exists in the IC tag 820, the extension command transforming unit 140, by using the CPU 911, advances to the extension operation size calculating step S645.

When the block number deciding unit 247 decides that the block having the block number stored by the block number storing unit 246 does not exist in the IC tag 820, the extension command transforming unit 140 ends the block operation command transforming process.

In the extension operation size calculating step S645, the extension operation size calculating unit 243, by using the CPU 911, calculates the extension operation size, based on the block size inputted by the block size acquiring unit 144 in the common operation size etc acquiring step S641, the extension start address calculated by the extension start address calculating unit 242 in the extension start address calculating step S642 and the remaining size stored by the remaining size storing unit 241.

In the extension command generating step S646, the extension command generating unit 249, by using the CPU 911, generates the extension block operation command, based on the extension command inputted by the extension command acquiring unit 143 in the common operation size etc acquiring step S641, the block number stored by the block number storing unit 246, the extension start address calculated by the extension start address calculating unit 242 in the extension start address calculating step S642, and the extension operation size calculated by the extension operation size calculating unit 243 in the extension operation size calculating step S645.

In the remaining size calculating step S647, the remaining size calculating unit 244, by using the CPU 911, calculates the new remaining size, based on the remaining size stored by the remaining size storing unit 241, and the extension operation size calculated by the extension operation size calculating unit 243 in the extension operation size calculating step S645. The remaining size storing unit 241, by using the RAM 914, stores the new remaining size calculated by the remaining size calculating unit 244.

When the remaining size calculated by the remaining size calculating unit 244 is greater than “0”, the extension command transforming unit 140, by using the CPU 911, proceeds to the block number updating step S648.

When the remaining size calculated by the remaining size calculating unit 244 is equal to “0”, the extension command transforming unit 140, by using the CPU 911, ends the block operation command transforming process.

In the block number updating step S648, the block number updating unit 248, by using the CPU 911, updates the block number by adding 1 to the block number stored by the block number storing unit 246. The block number storing unit 246, by using the RAM 914, stores the updated block number.

After that, the extension command transforming unit 140, by using the CPU 911, returns to the block number deciding step S644.

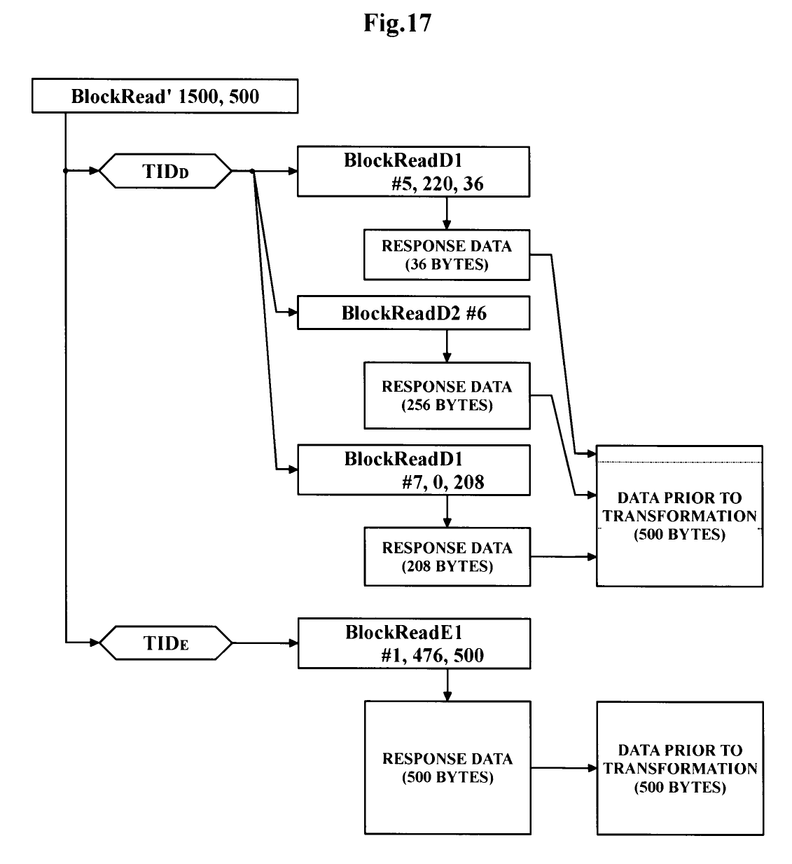

FIG. 17 illustrates the specific example of the relation between the common block operation command and the extension block operation command transformed by the extension command transforming unit 140, and the relation between the response data and the transformed data transformed by the response transforming unit 150.

In this example, the common command acquiring unit 161 acquires the common command “block read’ 1500 500” as the common block operation command, that instructs to read “500” bytes of the data, specified as the common operation size, beginning at the address number “1500”, specified as the common start address.

The IC tag 820 having “TIDD” as TID can interpret “BlockReadD1” as the extension block operation command, where the block number, the extension start address and the extension operation size are specified, and that instructs to read altogether the plurality of data stored on the memory area indicated by the extension start address and the extension operation size, among the memory area indicated by the specified block number. Moreover, the IC tag 820 having “TID_{D}” as TID can interpret “BlockReadD2”, where the block number only is specified, and that instructs to read altogether all the data stored on the memory area indicated by the specified block number. Meanwhile, assume that the block size of the IC tag 820 of the manufacturer D is 256 bytes, the block amount is 16, and the start block number is 0.

Likewise, the IC tag 820 having “TID_{E}” as TID can interpret “BlockReadE1”, where the block number, the extension start address and the extension operation size are specified, and that instructs to read altogether the plurality of data. Meanwhile, assume that the block size of the IC tag 820 of the manufacturer E is 1024 bytes, the block amount is 8, and the start block number is 0.

For example, the case will be shown that a protocol decided by the protocol deciding unit 130 based on the TID received by the identification receiving unit 181 is “TID_{D}”. The common operation size acquiring unit 141, by using the CPU 911, acquires the common operation size “500”. The common start address acquiring unit 142, by using the CPU 911, acquires the common start address “1500”. The extension command acquiring unit 143, by using the CPU 911, inputs the extension block operation commands “BlockReadD1” and “BlockReadD2”. The block size acquiring unit 144, by using the CPU 911, inputs the block size “256”. The block amount acquiring unit 145, by using the CPU 911, inputs the block amount “16”. The start block number acquiring unit 146, by using the CPU 911, inputs the block number “0”. The remaining size storing unit 241, by using the RAM 914, stores the common operation size “500” as the remaining size.

The extension start address calculating unit 242, by using the CPU 911, sets a remainder “220” obtained from dividing the common start address “1500” by the block size “256” as the extension start address. The block number calculating unit 245, by using the CPU 911, sets a sum “5” of the quotient “5” obtained from dividing the common start address “1500” by the block size “256” and the start block number “0”, as the block number. The block number deciding unit 247, by using the CPU 911, decides that this block is present in the IC tag 820 because a sum “16” of the block amount “16” and the start block number “0” is greater than the block number “5”.

The extension operation size calculating unit 243, by using the CPU 911, compares a difference “36” obtained by deducting the extension start address “220” from the block size “256”, with the remaining size “500”, and sets the smaller one “36” as the extension operation size.

The extension command generating unit 249, by using the CPU 911, based on the block number “5”, the extension start address “220”, and the extension operation size “36”, generates and outputs the extension block operation command “BlockReadD1 #5, 220, 36”.

The remaining size calculating unit 244, by using the CPU 911, calculates a difference “464” obtained by deducting the extension operation size “36” from the remaining size “500”, and the remaining size storing unit 241 stores it as the remaining size.

Since the remaining size “464” is greater than “0”, the block number updating unit 248, by using the CPU 911, adds “1” to the block number “5” to get “6”, and the block number storing unit 246 stores it as the block number.

The block number deciding unit 247, by using the CPU 911, decides that a block having the block number “6” is present in the IC tag 820. The extension operation size calculating unit 243, by using the CPU 911, compares the block size “256” with the remaining size “464”, and sets the smaller one “256” as the extension operation size.

The extension command generating unit 249, by using the CPU 911, based on the block number “6” and the extension operation size “256”, generates and outputs the extension block operation command “BlockEeadD2 #6”. Meanwhile, in this example, the extension command generating unit 249 may have a configuration for generating the extension block operation command “BlockReadD1 #6, 0, 256”However, it is better to select and generate “block read D2 #6” for reading all of the data in a single block, because it is more efficient.

The remaining size calculating unit 244, by using the CPU 911, calculates a difference “208” obtained by deducting the extension operation size “256” from the remaining size “464”, and the remaining size storing unit 241 stores it as the remaining size.

Since the remaining size “208” is greater than “0”, the block number updating unit 248, by using the CPU 911, adds “1” to the block number “6” to get “7”, and the block number storing unit 246 stores it as the block number.

The block number deciding unit 247, by using the CPU 911, decides that a block with the block number “7” is present in the IC tag 820. The extension operation size calculating unit 243, by using the CPU 911, compares the block size “256” with the remaining size “208”, and sets the smaller one “208” as the extension operation size.

The extension command generating unit 249, by using the CPU 911, based on the block number “7” and the extension operation size “208”, generates and outputs the extension block operation command “BlockReadD1 #7, 0, 208”.

The remaining size calculating unit 244, by using the CPU 911, calculates a difference “0” obtained by deducting the extension operation size “208” from the remaining size “208”, and the remaining size storing unit 241 stores it as the remaining size.

Since the remaining size is “0”, the extension command transforming unit 140 ends the block operation command transforming process.

Three extension block operation commands generated by the extension command transforming unit 140 are transmitted to the IC tag 820 by the command transmitting unit 172, and the IC tag 820 transmits the response data to each of the extension block operation commands. The response receiving unit 182 receives the three response data transmitted by the IC tag 820, and the response transforming unit 150 inputs them.

For example, the response transforming unit 150, by using the CPU 911, combines the inputted three response data to get the data prior to transformation, adjusts the data format, and generates the single transformed data. The response notifying unit 162, by using the communication apparatus 915, notifies the PC 810 of the transformed data generated by the response transforming unit 150, as a response to the common block operation command “BlockRead’ 1500, 500” acquired by the common command acquiring unit 161.

For example, the case will be shown that a protocol decided by the protocol deciding unit 130 based on the TID received by the identification receiving unit 181 is “TIDE”. The common operation size acquiring unit 141, by using the CPU 911, acquires the common operation size “500”. The common start address acquiring unit 142, by using the CPU 911, acquires the common start address “1500”. The extension command acquiring unit 143, by using the CPU 911, inputs the extension block operation command “BlockReadE1”. The block size acquiring unit 144, by using the CPU 911, inputs the block size “1024”. The block amount acquiring unit 145, by using the CPU 911, inputs the block amount “8”. The start block number acquiring unit 146, by using the CPU 911, inputs the start block number “0”. The remaining size storing unit 241, by using the RAM 914, stores the common operation size “500” as the remaining size.

The extension start address calculating unit 242, by using the CPU 911, sets a remainder “476” obtained from dividing the common start address “1500” by the block size “1024”, as the extension start address. The block number calculating unit 245, by using the CPU 911, sets a sum “1” of the quotient “1” obtained from dividing the common start address “1500” by the block size “1024” and the start block number “0”, as the block number. The block number deciding unit 247, by using the CPU 911, decides that the block is present in the IC tag 820 because a sum “8” of the block amount “8” and the start block number “0” is greater than the block number “1”.

The extension operation size calculating unit 243, by using the CPU 911, compares a difference “548” obtained by deducting the extension start address “476” from the block size “1024” with the remaining size “500”, and sets the smaller one “500” as the extension operation size.

The extension command generating unit 249, by using the CPU 911, based on the block number “1”, the extension start address “476”, and the extension operation size “500”, generates and outputs the extension block operation command “BlockReadE1 #1, 476, 500”.

The remaining size calculating unit 244, by using the CPU 911, calculates a difference “0” obtained by deducting the extension operation size “500” from the remaining size “500”, and the remaining size storing unit 241 stores it as the remaining size.

Since the remaining size is “0”, the extension command transforming unit 140 ends the block operation command transforming process.

The extension block operation commands generated by the extension command transforming unit 140 are transmitted to the IC tag 820 by the command transmitting unit 172, and the IC tag 820 transmits the response data for each one of the extension block operation commands. The response receiving unit 182 receives the response data transmitted by the IC tag 820, and the response transforming unit 150 inputs them

For example, the response transforming unit 150, by using the CPU 911, deals the inputted response data as the data prior to transformation, adjusts the data format, and generates the transformed data. The response notifying unit 162, by using the communication apparatus 915, notifies the PC 810 of the transformed data generated by the response transforming unit 150 as a response to the common block operation command “BlockRead’ 1500, 500” acquired by the common command acquiring unit 161.

Since the IC tag 820 manages the memory area by dividing it into a plurality of blocks, even if the IC tag 820 interprets the block operation command that operates altogether a plurality of operation subjected data, an area across a boundary of the blocks cannot be operated altogether in some cases.

Moreover, depending on the types of the IC tag 820 (the manufacturers and model types), their block sizes may differ in some cases.

The RFID reader/writer apparatus 100 according to the present embodiment, when the acquired common command is serving as the common block operation command, obtains a block size of the IC tag 820 based on the TID of the IC tag 820. When a memory area of the operation subjected data extends across the block boundary, the RFID reader/writer apparatus 100 transforms a single common block operation command into a plurality of the extension block operation commands. The transformed extension block operation commands operate data of a memory area that does not extend across the block boundary.

Accordingly, the plurality of operation subjected data can be operated altogether, with a single common block operation command, regardless of the block size of the IC tag 820.

According to the data operation apparatus (the RFID reader/writer apparatus 100) of the present embodiment, the extension command transforming unit 140, by using the processing apparatus (the CPU 911), when deciding that the common command acquired by the common command acquiring unit 161 is the common block operation command, acquires an operation specifying data (the common start address, the common operation size) that specifies the plurality of operation subjected data which is subjected to operation altogether from the common command acquired by the common command acquiring unit 161. Based on the block size 524 stored by the protocol storing unit 120 for the group of the extension commands (the protocols) decided by the command group deciding unit (protocol deciding unit 130), the extension command transforming unit 140 divides the plurality of operation subjected data specified by the acquired operation specifying data in terms of the operation blocks including the operation subjected data, and generates the extension commands (the extension block operation commands) that operate the operation subjected data. Each of the extension commands operates each one of the operation subjected data divided in terms of the operation blocks.

According to the data operation apparatus (the RFID reader/writer apparatus 100) of the present embodiment, even if the storage apparatuses (the IC tag 820) having different block sizes are mixedly present, the control apparatus (the PC 810) side does not need to be aware of that, and the data stored by the storage apparatus having different block sizes can be operated altogether with the same common block operation command.

The RFID reader/writer apparatus 100 described above, when accessing the user memory (the memory area) of the IC tag 820 (the storage apparatus) across the block boundary generates an error and cannot be processed properly, divides the user command (the common command) that instructs to access across the block boundary, in terms of the block boundary, and transforms to the extension commands that make accesses divided into a plurality of times. The protocol table (the protocol storing unit 120) have the block sizes 524. Based on this, the extension command transforming unit 140 divides the air command appropriately, even if the accesses are made toward the IC tags 820 having various block sizes. Therefore, the user can access the IC tag 820 without having to be aware of the block size.

### Fifth Embodiment

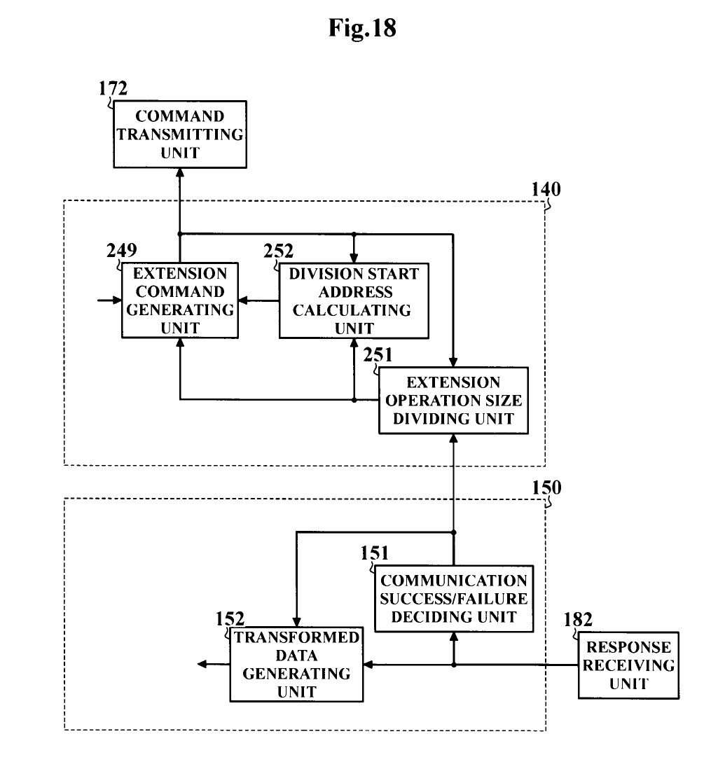

The fifth embodiment will be described with reference to the drawings of FIGS. 18 to 21.

The explanation is omitted for the portions that are equivalent to the IC tag readout system 800 described in the fourth embodiment since the identical reference numerals are being used.

In the present embodiment, the RFID reader/writer apparatus 100 having a configuration that automatically performs a retry when the communication with the IC tag 820 fails.

FIG. 18 is the block configuration chart showing one example of the detailed block configuration of the extension command transforming unit 140 and the response transforming unit 150, in accordance with the present embodiment.

Meanwhile, the portions related to the retry only are illustrated in this drawing.

The response transforming unit 150 includes a communication success/failure deciding unit 151, and a transformed data generating unit 152.

The communication success/failure deciding unit 151, by using the CPU 911, inputs the response data outputted by the response receiving unit 182. The communication success/failure deciding unit 151, by using the CPU 911, based on the inputted response data, decides if the communication with the IC tag 820 is succeeded or failed. The communication success/failure deciding unit 151, by using the CPU 911, outputs the decided result.

For example, when the extension command transmitted by the command transmitting unit 172 is the block read command, the communication success/failure deciding unit 151, by using the CPU 911, checks an error detection code or error correction code attached to the inputted response data, and decides whether or not the response data is properly received by the response receiving unit 182. Alternatively, when the extension command transmitted by the command transmitting unit 172 is the block write command, the response data that includes information indicating whether or not the data to be written to the IC tag 820 is correctly received by the IC tag 820, is transmitted by the IC tag 820. Therefore, the communication success/failure deciding unit 151 analyzes this and decides whether or not the data is correctly received by the IC tag 820.

The transformed data generating unit 152, by using the CPU 911, inputs the decided result outputted by the communication success/failure deciding unit 151. The transformed data generating unit 152, by using the CPU 911, based on the decided result inputted, when the communication success/failure deciding unit 151 decides that the communication with the IC tag 820 is succeeded, inputs the response data outputted by the response receiving unit 182. The transformed data generating unit 152, by using the CPU 911, transforms the response data inputted, to generate the transformed data. The transformed data generating unit 152, by using the CPU 911, outputs the generated transformed data.

The extension command transforming unit 140 further includes an extension operation size dividing unit 251, and a division start address calculating unit 252, in addition to the functional block described in the fourth embodiment.

The extension operation size dividing unit 251, by using the CPU 911, inputs the decided result outputted by the communication success/failure deciding unit 151. The extension operation size dividing unit 251, by using the CPU 911, based on the decided result inputted, when the communication success/failure deciding unit 151 decides that the communication with the IC tag 820 is failed, inputs an extension operation size specified in the extension command outputted by the extension command generating unit 249. The extension operation size dividing unit 251, by using the CPU 911, compares the inputted extension operation size with a prescribed minimum size (for example, 8 bytes). The extension operation size dividing unit 251, by using the CPU 911, divides the inputted extension operation size into a prescribed number (for example, 2) (hereinafter referred to as the “division number”) when deciding that the inputted extension operation size is greater than the prescribed minimum size.

For example, if the division number is 2, the extension operation size dividing unit 251, by using the CPU 911, divides the inputted extension operation size by 2, and calculates two division operation sizes. The division operation sizes are integers, total of which is made to be equal to the inputted extension operation size. Moreover, considering an efficiency of the memory access, the extension operation size dividing unit 251, by using the CPU 911, may have a configuration that calculates the division operation size so that the divided memory area coincides with a word boundary.

Moreover, when the extension operation size dividing unit 251, by using the CPU 911, decides that the inputted operation size is less than or equal to the prescribed minimum size, the extension operation size dividing unit 251 outputs the inputted extension operation size as the division operation size without change. Accordingly, the division number in this case is “1”.

The division start address calculating unit 252, by using the CPU 911, inputs the division operation size outputted by the extension operation size dividing unit 251, and the extension start address specified in the extension command outputted by the extension command generating unit 249. The division start address calculating unit 252, by using the CPU 911, based on the inputted division operation size, calculates the extension start address for each one of the extension commands divided (hereinafter referred to as the “division start address”). The division start address calculating unit 252, by using the CPU 911, outputs the calculated division start addresses.

The division start address calculating unit 252, by using the CPU 911, calculates the same number of the division start addresses as the division number. For example, when the division number is 2, the division start address calculating unit 252, by using the CPU 911, calculates the two division start addresses. The division start address calculating unit 252, by using the CPU 911, sets the inputted extension start address as the first division start address without change. The division start address calculating unit 252, by using the CPU 911, adds the first division operation size, out of the two division operation sizes inputted, to the first division start address to get the second division start address.

The extension command generating unit 249, by using the CPU 911, inputs the division operation size outputted by the extension operation size dividing unit 251, and the division start address outputted by the division start address calculating unit 252. The extension command generating unit 249, by using the CPU 911, based on the inputted division operation size and the division start address, specifies the inputted division start address as the extension start address, specifies the inputted division operation size as the extension operation size, and generates the extension command. Meanwhile, as a block number, the same block number as the block number of the previous extension command where the communication is failed, is specified. The extension command generating unit 249 outputs the generated extension command.

The extension command generating unit 249, by using the CPU 911, generates the same number of the extension commands as the division number. For example, when the division number is 2, the extension command generating unit 249, by using the CPU 911, generates the two extension commands. The extension command generating unit 249, by using the CPU 911, generates the first extension command where the first division operation size is specified as the extension operation size and the first division start address is specified as the extension start address, and generates the second extension command where the second division operation size is specified as the extension operation size and the second division start address is specified as the extension start address.

The command transmitting unit 172, by using the CPU 911, inputs the extension command generated by the extension command generating unit 249. The command transmitting unit 172, by using the transmitting apparatus 917, transmits the inputted extension command to the IC tag 820.

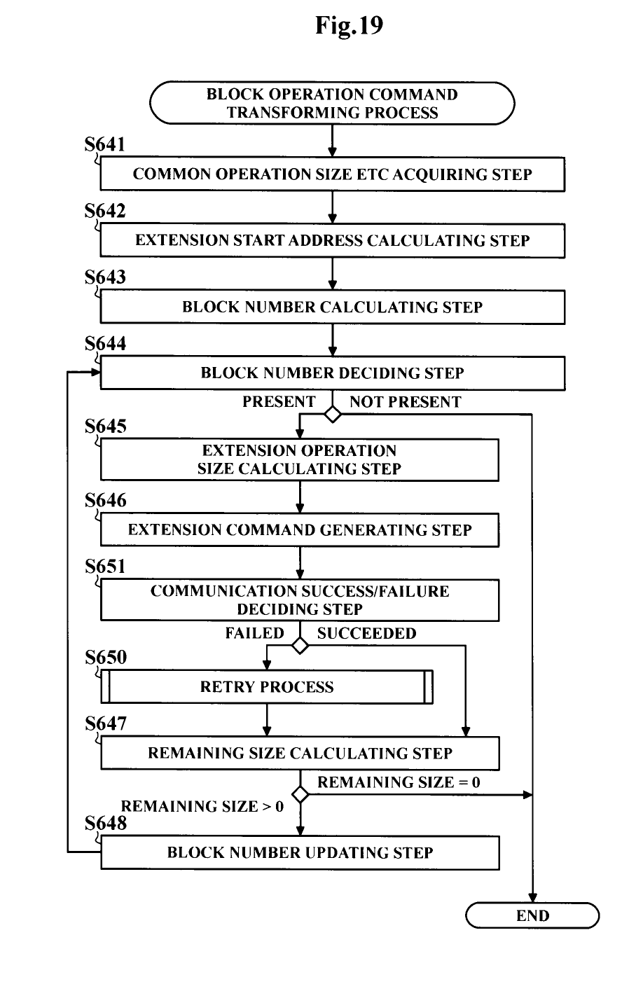

FIG. 19 is the flowchart showing one example of the flow of the block operation command transforming process in which the extension command transforming unit 140 of the present embodiment transforms the block operation command.

The block operation command transforming process further includes a communication success/failure deciding step S651 and a retry process S650, in addition to the step described in the fourth embodiment.

In the communication success/failure deciding step S651, the communication success/failure deciding unit 151, by using the CPU 911, decides whether the communication with the IC tag 820 is succeeded or failed, based on the response data transmitted by the IC tag 820, as a response to the extension command generated by the extension command generating unit 249 in the extension command generating step S646.

When the communication success/failure deciding unit 151 decides that the communication with the IC tag 820 is succeeded, the extension command transforming unit 140 proceeds to the remaining size calculating step S647.

When the communication success/failure deciding unit 151 decides that the communication with the IC tag 820 is failed, the extension command transforming unit 140 proceeds to the retry process S650.

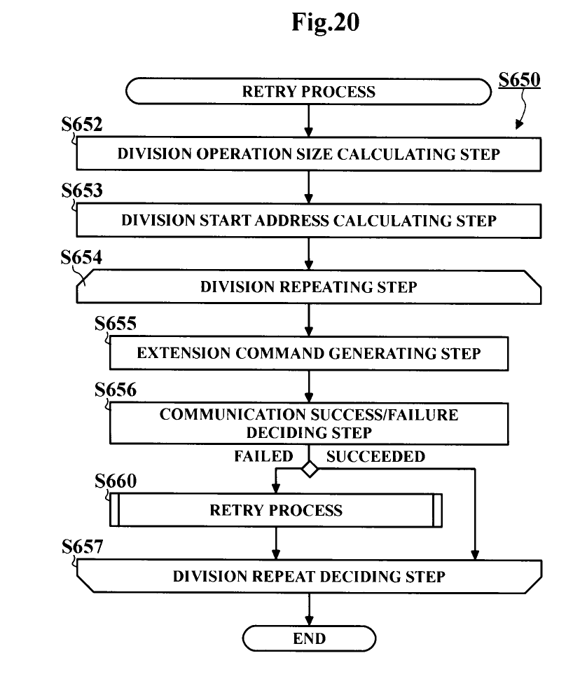

FIG. 20 is a flowchart showing one example of the flow of a retry process S650 in which the extension command transforming unit 140 of the present embodiment performs a retry.

The retry process S650 includes a division operation size calculating step S652, a division start address calculating step S653, a division repeating step S654, an extension command generating step S655, a communication success/failure deciding step S656, a retry processing S660, and a division repeat deciding step S657.

In the division operation size calculating step S652, the extension operation size dividing unit 251, by using the CPU 911, calculates the same number of the division operation sizes as the division number, based on the extension operation size specified by the extension command generated by the extension command generating unit 249.

In the division start address calculating step S653, the division start address calculating unit 252, by using the CPU 911, calculates the same number of the division start address as the division number, based on the division operation size calculated by the extension operation size dividing unit 251 in the division operation size calculating step S652, and the extension start address specified in the extension command generated by the extension command generating unit 249.

In the division repeating step S654, the extension command transforming unit 140, by using the CPU 911, repeats from the extension command generating step S655 to the division repeat deciding step S657 by the same number of times as the division number.

In the extension command generating step S655, the extension command generating unit 249, by using the CPU 911, specifies the block number stored by the block number storing unit 246 as the block number, specifies the division start address calculated by the division start address calculating unit 252 in the division start address calculating step S653 as the extension start address, specifies the division operation size calculated by the extension operation size dividing unit 251 in the division operation size calculating step S652 as the extension operation size, and generates and outputs the extension command.

The command transmitting unit 172, by using the transmitting apparatus 917, transmits the extension command generated by the extension command generating unit 249 to the IC tag 820. The IC tag 820 transmits a response data to this, and the response receiving unit 182 receives it.

In the communication success/failure deciding step S656, the communication success/failure deciding unit 151, by using the CPU 911, based on the response data received by the response receiving unit 182, decides whether the communication with the IC tag 820 is succeeded or failed.

When the communication success/failure deciding unit 151 decides that the communication with the IC tag 820 is succeeded, the extension command transforming unit 140, by using the CPU 911, proceeds to the division repeat deciding step S657.

When the communication success/failure deciding unit 151 decides that the communication with the IC tag 820 is failed, the extension command transforming unit 140, by using the CPU 911, proceeds to a retry process S660.

The retry process S660 is the same process as the retry process S650, which is executed recursively. In the retry process S660, the extension command transforming unit 140 further divides the extension command generated in the extension command generating step S655. Accordingly, until the communication with the IC tag 820 becomes succeeded, the size of the operation subjected data is made smaller and smaller. By making the size of the data for transmission and reception small, even if the communication environment is not good, a probability of making the communication with the IC tag 820 succeeded becomes high.

In the division repeat deciding step S657, the extension command transforming unit 140, by using the CPU 911, decides whether or not the processes from the extension command generating step S655 to the division repeat deciding step S657 are repeated by the same number of times as the division number.

When deciding that the number of repeat times is not sufficient, the extension command transforming unit 140, by using the CPU 911, repeats the process from the extension command generating step S655.

When deciding that the number of repeat times is the same as the division number, the extension command transforming unit 140, by using the CPU 911, ends the retry process.

Meanwhile, the configuration maybe as below: an upper limit is set beforehand to a depth of executing recursively the retry process; the extension command transforming unit 140, by using the CPU 911, decides whether the execution depth exceeds the upper limit or not, before the retry process S660; and when the execution depth exceeds the upper limit, the extension command transforming unit 140 gives up the retry and processes as a communication error.

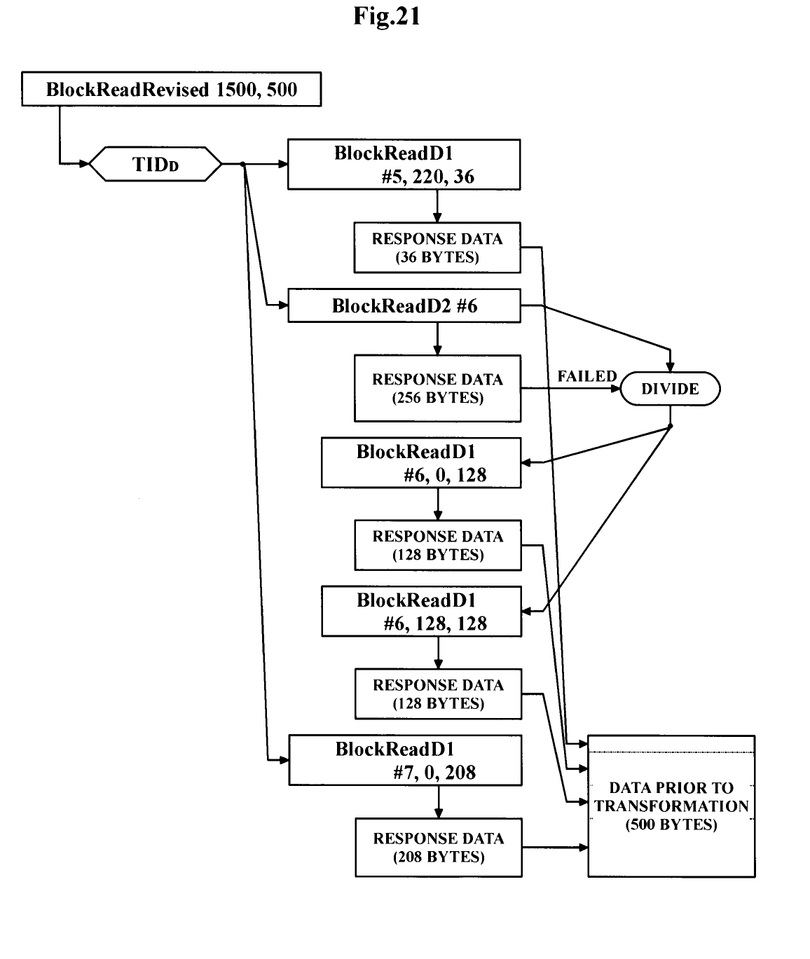

FIG. 21 illustrates the specific example of the relations between the common block operation command and the extension operation commands transformed by the extension command transforming unit 140, and the relations between the response data and the transformed data transformed by the response transforming unit 150, in accordance with the present embodiment.

This case is: in the example described in the fourth embodiment, the communication with the IC tag 820 is failed when performing the second extension command “BlockReadD2 #6” generated by the extension command transforming unit 140.

The communication success/failure deciding unit 151, by using the CPU 911, based on the response data received by the response receiving unit 182, decides that the communication with the IC tag 820 is failed. The extension operation size dividing unit 251, by using the CPU 911, divides the extension operation size “256” specified in the extension command “BlockReadD2 #6” by “2”, and calculates two second division operation sizes “128” and “128”. The division start address calculating unit 252, by using the CPU 911, sets the extension start address “0” of the extension command “block read D2 #6” as the first division start address, and adds the first division operation size “128” calculated by the extension operation size dividing unit 251 to this, to calculate the second division start address “128”.

The extension command transforming unit 140, by using the CPU 911, specifies the block number “6” specified in the extension command “block read D2 #6” as the block number, and specifies the first division start address “0” calculated by the division start address calculating unit 252 as the extension start address, specifies the first division operation size calculated by the extension operation size dividing unit 251 as the extension operation size, and generates and outputs the extension command “BlockReadD1 #6, 0, 128”.

The command transmitting unit 172, by using the transmitting apparatus 917, transforms the extension command “block read D1 #6, 0, 128” generated by the extension command transforming unit 140 to the IC tag 820, and the IC tag 820 receives it. The IC tag 820 transmits the response data in reply to this, and the response receiving unit 182 receives it by using the receiving apparatus 918. Herein, assume that the communication with the IC tag 820 is succeeded.

The communication success/failure deciding unit 151, by using the CPU 911, based on the response data received by the response receiving unit 182, decides the communication with the IC tag 820 is succeeded.

The extension command transforming unit 140, by using the CPU 911, specifies the block number “6” specified in the extension command “BlockReadD2 #6” as the block number, specifies the second division start address “128” calculated by the division start address calculating unit 252 as the extension start address, and specifies the second division operation size calculated by the extension operation size dividing unit 251 as the extension operation size, and generates and outputs the extension command “BlockReadD1 #6, 128, 128”.

The command transmitting unit 172, by using the transmitting apparatus 917, transmits the extension command “BlockReadD1 #6, 128, 128” generated by the extension command transforming unit 140 to the IC tag 820, and the IC tag 820 receives it. The IC tag 820 transmits the response data in reply to this, and the response receiving unit 182 receives it by using the receiving apparatus 918.

As described accordingly, when the communication with the IC tag 820 is failed, the probability of making the communication success is increased by making the size of the transmission and reception data smaller. As well, the portions of the successful communication do not need to be retransmitted, therefore, as a whole, a time taken to communicate with the IC tag 820 can be shortened.

The data operation apparatus (the RFID reader/writer apparatus 100) of the present embodiment further includes the communication success/failure deciding unit 151.

The communication success/failure deciding unit 151, by using the processing apparatus (the CPU 911), based on the response data received by the response receiving unit 182, decides whether the communication with the storage apparatus (the IC tag 820) is succeeded or failed.

The extension command transforming unit 140, by using the processing apparatus (the CPU 911), when the communication success/failure deciding unit 151 decides that the communication with the storage apparatus (the IC tag 820) is failed, retransforms the common command into the extension commands, where the data length of transmission and reception at one communication is shorter than the transformed extension command.

The extension command transmitting unit 172, by using the transmitting apparatus 917, transmits the extension command retransformed by the extension command transforming unit 140 to the storage apparatus (the IC tag 820).

According to the data operation apparatus (the RFID reader/writer apparatus 100) of the present embodiment, when the communication with the storage apparatus (the IC tag 820) is failed, the extension command transforming unit 140 retransforms to the extension command having a short transmission and reception data length. Therefore, the probability of making the communication succeeded is increased.

The data operation apparatus (the RFID reader/writer apparatus 100) of the present embodiment further includes the communication success/failure deciding unit 151.

The communication success/failure deciding unit 151, by using the processing apparatus (the CPU 911), for each one of the at least one extension command transformed by the extension command transforming unit 140, based on the response data received by the response receiving unit 182, decides if the communication with the storage apparatus (the IC tag 820) is succeeded or failed.

The extension command transforming unit 140, by using the processing apparatus (the CPU 911), when the communication success/failure deciding unit 151 decides that a communication with the storage apparatus (the IC tag 820) is failed for any one of the at least one extension command transformed by the extension command transforming unit 140, divides the operation subjected data to be operated into the plurality of the operation subjected data, for the extension command decided by the communication success/failure deciding unit 151 that the communication with the storage apparatus is failed; generates an extension command for each one of the operation subjected data divided, to transform the extension command where the communication is failed, into the plurality of extension commands.

The extension command transmitting unit 172, by using the transmitting apparatus 917, transmit the plurality of extension commands transformed by the extension command transforming unit 140, to the storage apparatus (the IC tag 820).

According to the data operation apparatus (the RFID reader/writer apparatus 100) of the present embodiment, for the extension command that operates the plurality of data altogether, when the communication with the IC tag 820 is failed, the extension command transforming unit 140 transforms the extension command by dividing the operation subjected data, so that the communication success rate is increased.

The RFID reader/writer apparatus 100 described above, when the difference of the communication performances depending on the tag types or the like blocks the communication with the IC tag 820 to success, it can be saved by the retry. When the data length of the communication is long, the efficiency of the communication is improved, but a probability of communication failure also increases. Therefore, a balance between the efficiency and the success rate is maintained by making the data length shorter at each retry. By increasing the number of retry times, a transmission size (the extension operation size) is gradually reduced. The extension command transforming unit 140, by using the block size, decides the transmission size. When the communication is succeeded, the communication is performed in the block size. So, the communication efficiency can be improved. When the communication is failed, making the data length shorten (for example, halved) increases the success rate of the communication.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

What is claimed is:

1. A data operation apparatus that communicates with a storage apparatus according to an instruction from a control apparatus, and operates data stored by the storage apparatus, the data operation apparatus comprising
a processing apparatus for processing data,
a transmitting apparatus for transmitting data to the storage apparatus,
a receiving apparatus for receiving data from the storage apparatus,
a common command acquiring unit,
an identification acquirement instructing unit,
an identification receiving unit,
a command group deciding unit,
an extension command transforming unit,
an extension command transmitting unit,
a response receiving unit,
a response transforming unit, and
a response notifying unit;
wherein the common command acquiring unit, by using the processing apparatus, acquires a common command for indicating the instruction from the control apparatus;
wherein the identification acquirement instructing unit, by using the transmitting apparatus, transmits to the storage apparatus an identification acquiring command for instructing to transmit an identification information of the storage apparatus;
wherein the identification receiving unit, by using the receiving apparatus, receives the identification information transmitted by the storage apparatus in response to the identification acquiring command transmitted by the identification acquirement instructing unit;
wherein the command group deciding unit, by using the processing apparatus, decides a group of a extension command that the storage apparatus interprets, among a plurality of groups of the extension command, based on the identification information received by the identification receiving unit;
wherein the extension command transforming unit, by using the processing apparatus, transforms the common command acquired by the common command acquiring unit, into an extension command that the storage apparatus interprets, based on the group of the extension command decided by the command group deciding unit;
wherein the extension command transmitting unit, by using the transmitting apparatus, transmits to the storage apparatus the extension command transformed by the extension command transforming unit;
wherein the response receiving unit, by using the receiving apparatus, receives a response data transmitted by the storage apparatus in response to the extension command transmitted by the extension command transmitting unit;
wherein the response transforming unit, by using the processing apparatus, transforms a data format of the response data received by the response receiving unit into a prescribed format, to generate a transformed data; and
wherein the response notifying unit, by using the processing apparatus, notifies the control apparatus of the transformed data generated by the response transforming unit in response to the common command acquired by the common command acquiring unit.

2. The data operation apparatus according to claim 1, further comprising a command deciding unit and a basic command transforming unit;
wherein the command deciding unit, by using the processing apparatus, decides whether or not the common command acquired by the common command acquiring unit is a command transformable to a basic command that a storage apparatus interprets regardless of type of the storage apparatus;
wherein the basic command transforming unit, by using the processing apparatus, transforms the common command acquired by the common command acquiring unit to the basic command, when the command deciding unit decides that the common command acquired by the common command acquiring unit is the command transformable to the basic command; and
wherein the extension command transmitting unit, by using the transmitting apparatus, transmits to the storage apparatus the basic command transformed by the basic command transforming unit, when the command deciding unit decides that the common command acquired by the common command acquiring unit is the command transformable to the basic command; and, by using the transmitting apparatus, transmits to the storage apparatus the extension command transformed by the extension command transforming unit, when the command deciding unit decides that the common command acquired by the common command acquiring unit is not the command transformable to the basic command.

3. The data operation apparatus according to claim 1, further comprising an inner storage apparatus for storing data, and a protocol storing unit;
wherein the protocol storing unit, by using the inner storage apparatus, stores a block size for indicating a number of data included in a single operation block serving as an unit of a plurality of data stored by the storage apparatus, the unit being operated altogether, corresponding to each group of the extension commands to be decided by the command group deciding unit;
wherein the extension command transforming unit, by using the processing apparatus, decides whether or not the common command acquired by the common command acquiring unit is a common block operation command for instructing to operate the plurality of data altogether stored by the storage apparatus; and when deciding that the common command is the common block operation command, transforms the common command into the extension command, based on the block size stored by the protocol storing unit, corresponding to the group of the extension command to be decided by the command group deciding unit.

4. The data operation apparatus according to claim 3, wherein the extension command transforming unit, by using the processing apparatus, when having decided that the common command acquired by the common command acquiring unit is the common block operation command, acquires an operation specifying data for specifying a plurality of operation subjected data to be subjected to operation altogether, from the common command acquired by the common command acquiring unit; divides the plurality of operation subjected data specified by the operation specifying data acquired, in terms of an operation block for including the operation subjected data, based on the block size stored by the protocol storing unit corresponding to the group of the extension command decided by the command group deciding unit; and generates the extension command for operating each of the operation subjected data divided in terms of the operation block.

5. The data operation apparatus according to claim 3, wherein the protocol storing unit comprises a plurality of table storing units, a valid flag storing unit, a table updating unit, and a table switching unit;
wherein each one of the plurality of the table storing units, by using the inner storage apparatus, stores a protocol table including an extension command, the storage apparatus interpreting the extension command, and a block size corresponding to each of the group of the extension command to be decided by the command group deciding unit;
wherein the valid flag storing unit, by using the inner storage apparatus, stores a valid flag for indicating which one of the plurality of the table storing units is valid;
wherein the table updating unit, by using the processing apparatus, when the common command acquired by the common command acquiring unit is a command for instructing to update the protocol table, updates the protocol table stored by the invalid one of the plurality of the table storing units, based on the valid flag stored by the valid flag storing unit; and
wherein the table switching unit, by using the processing apparatus, updates the valid flag stored by the valid flag storing unit, to make valid the table storing unit updated by the table updating unit.

6. The data operation apparatus according to claim 3, further comprising a non-volatile inner storage apparatus for storing data;
wherein the protocol storing unit comprises a plurality of master storing units, a master valid flag storing unit, a table updating unit, a table switching unit, and a table storing unit;
wherein each one of the plurality of the master storing units, by using the non-volatile inner storage apparatus, stores a protocol table including an extension command, the storage apparatus interpreting the extension command, and a block size corresponding to each of the group of the extension command to be decided by the command group deciding unit;
wherein the master valid flag storing unit, by using the inner storage apparatus, stores a master valid flag for indicating which one of the plurality of master storing units is valid;
wherein the table updating unit, by using the processing apparatus, when the common command acquired by the common command acquiring unit is a command for instructing to update the protocol table, updates the protocol table stored by the invalid one of the master storing units, based on the master valid flag stored by the master valid flag storing unit;
wherein the table switching unit, by using the processing apparatus, updates the master valid flag stored by the master valid flag storing unit, to make valid the master storing unit updated by the table updating unit; and
wherein the table storing unit, by using the inner storage apparatus, reads and stores the protocol table stored by the valid master storing unit, based on the master valid flag stored by the master valid flag storing unit.

7. The data operation apparatus according to claim 1, further comprising a communication success/failure deciding unit;
wherein the communication success/failure deciding unit, by using the processing apparatus, decides whether or not a communication with the storage apparatus is succeeded or failed, based on the response data received by the response receiving unit;
wherein the extension command transforming unit, by using the processing apparatus, when the communication success/failure deciding unit decides that the communication with the storage apparatus is failed, retransforms the common command to an extension command for instructing to transmit or to receive data, a length of the data at one communication being shorter than the transformed extension command; and
wherein the extension command transmitting unit, by using the transmitting apparatus, transmits to the storage apparatus the extension command retransformed by the extension command transforming unit.

8. The data operation apparatus according to claim 4, further comprising a communication success/failure deciding unit;
wherein the communication success/failure deciding unit, by using the processing apparatus, decides whether or not a communication with the storage apparatus is succeeded or failed, based on the response data received by the response receiving unit, corresponding to each of at least one of the extension command transformed by the extension command transforming unit;
wherein the extension command transforming unit, by using the processing apparatus, when the communication success/failure deciding unit decides that a communication with the storage apparatus is failed corresponding to any of the extension command transformed by the extension command transforming unit, transforms the extension command decided as failed to the plurality of extension commands, by dividing into plural number the operation subjected data to be operated by the extension command decided as failed, and by generating an extension command for operating each of the operation subjected data divided;
wherein the extension command transmitting unit, by using the transmitting apparatus, transmits to the storage apparatus the plurality of extension commands transformed by the command transforming unit.

9. The data operation apparatus according to claim 1, wherein the extension command transforming unit, by using the processing apparatus, transforms a single common command acquired by the common command acquiring unit into at least one extension command; and
wherein the response transforming unit, by using the processing apparatus, generates a single transformed data, based on the response data received by the response receiving unit, in response to each of the extension command transformed from the single common command by the extension command transforming unit.

10. A data operation system, comprising a plurality of storage apparatuses, and the data operation apparatus of claims 1;
wherein the plurality of storage apparatuses, interprets any group of the extension command among the plurality of groups of the extension command.

11. A computer program that makes a computer having the processing apparatus for processing data, function as the data operation apparatus of claim 1.

12. A data operation method that the data operation apparatus having a processing apparatus for processing data, a transmitting apparatus for transmitting data to a storage apparatus, and a receiving apparatus for receiving data from the storage apparatus, communicates with the storage apparatus according to an instruction from a control apparatus, and operates the data stored by the storage apparatus;
wherein the processing apparatus acquires a common command for indicating the instruction from the control apparatus;
wherein the transmitting apparatus transmits to the storage apparatus an identification acquiring command for instructing to transmit an identification information of the storage apparatus;
wherein the receiving apparatus receives an identification information transmitted by the storage apparatus in response to the identification acquiring command transmitted by the transmitting apparatus;
wherein the processing apparatus decides a group of an extension command that the storage apparatus interprets, among a plurality of groups of the extension command, based on the identification information received by the receiving apparatus;
wherein the processing apparatus transforms the acquired common command into the extension command that the storage apparatus interprets, based on the decided group of the extension command;
wherein the transmitting apparatus transmits to the storage apparatus the extension command transformed by the processing apparatus;
wherein the receiving apparatus receives a response data transmitted by the storage apparatus in response to the extension command transmitted by the transmitting apparatus;
wherein the processing apparatus transforms a data format of the response data received by the receiving apparatus into a prescribed format, to generate a transformed data; and
wherein the processing apparatus notifies the control apparatus of the generated transformed data in response to the acquired common command.
